(19) United States
(12) Patent Application Publication
(10) Pub. No.: US 2006/0005228 A1
(43) Pub. Date: Jan. 5, 2006

(54) Behavior model generator system for facilitating confirmation of intention of security policy creator

(75) Inventor: Katsushi Matsuda, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/116,359

(22) Filed: Apr. 28, 2005

(30) Foreign Application Priority Data
Jun. 18, 2004 (JP) 2004-180904

(51) Int. Cl. G06F 17/00

(52) U.S. Cl. 726/1

(57) ABSTRACT

A policy normalizing means normalizes an entered security policy. Specifically, if the security policy does not include necessary items, the policy normalizing means compensates the security policy for the missing items by predefined values so that the security policy includes the necessary items. An behavior model generating means generates an behavior model representative of the operation of a network access controller based on the normalized security policy. In this event, the behavior model generating means generates an behavior model which is represented by a data structure that is not dependent on the type of the network access controller. A modifying means modifies the behavior model in accordance with a modification principle desired by an operator, and a configuration generating means generates configuration for the network access controller from the modified behavior model.

### BACKGROUND OF THE INVENTION

1. Field of the Invention

The present invention relates to an behavior model generator system, an behavior model generating method, and an behavior model generating program for generating an behavior model which represents the operation of a network access controller from a security policy.

2. Description of the Related Art

A variety of techniques have been proposed for generating information for setting an network access controller from a security policy, for example, in JP-2003-140890-A, JP-2000-253066-A, and JP-2000-244495-A. Here, the network access controller refers to, for example, a device for performing network access control, such as packet filtering, and examples of the network access controller include, for example, a firewall, a router, a server device, and the like. The configuration in turn refers to information for defining the operation of a network access controller. The network access controller executes network access control such as packet filtering in accordance with setting contents described as the configuration. The configuration is described in a format appropriate to a particular network access controller.

An electronic device configuration generating method described in JP-2003-140890-A converts a high-level security policy (product level policy at a first level) described in a natural language to a general-purpose intermediate language (interface language). Then, the intermediate language is converted to a low-level security policy (product level policy at a second level) which is configuration described in a device-specific language by a script generating means provided for each particular device. The electronic device configuration generating method described in JP-2003-140890-A is implemented on the assumption that the conversion from the high-level security policy to the intermediate language, and the conversion from the intermediate language to the low-level security policy are made by converting the respective vocabularies to other vocabularies in one-to-one correspondence.

A method and apparatus for managing a firewall described in JP-2000-253066-A generate an entity relation model which represents a security policy for a communication network in a model definition language. Then, the entity relation model is translated into a firewall configuration file, which include device-specific configuration, by a model compiler.

A network management system described in JP-2000-244495-A lists up applications utilized by each user group (referred to as “Zone” in JP-2000-244495-A) which utilizes a network to automatically generate information for setting a firewall and a router.

There is also an ISMS (Information Security Management System) compatibility evaluation regime. This regime shows a systematized management scheme related to the security. A first step of the management scheme is to determine a basic policy for information security. The basic policy is the security policy which is a declarative policy related to the security described in a natural language. Since there is an increasingly strong tendency to practice a security management in accordance with the policy of the ISMS compatibility evaluation regime, the security policies often exist in those enterprises which wrestle with the security management.

The method described in JP-2003-140890-A converts a high-level security policy described in a natural language to a general-purpose intermediate language in a one-to-one correspondence, and further converts the intermediate language to a low-level security policy in a one-to-one correspondence. In this event, if the high-level security policy described in a natural language is not described according to an essential intention of a security policy creator, errors possibly included in the security policy will be reflected as they are to the low-level security policy (configuration ). In addition, since the configuration is described in a format specific to each device, it is quite difficult for an operator (for example, a system manager) to read the described configuration. It is therefore difficult to find descriptions which deviate from the intention of the security policy creator in the configuration, and also difficult to confirm whether or not the configuration is in line with the intention of the security policy creator. Stated another way, the method described in JP-2003-140890-A has a problem of “difficulties in confirming the intention of the security policy creator.”

Also, if there are a plurality of creators who have participated in the creation of a high-level security policy, the creators may differ from one another in design guideline for the security policy. As a result, the method described in JP-2003-140890-A can cause semantic discrepancies, inconsistent description formats and the like in a low-level security policy (configuration) generated from a high-level security policy (security policy described in a natural language), leading to difficulties in subsequent maintenance operations. In other words, the method described in JP-2003-140890-A has another problem of “difficulties in maintaining the consistency.”

A high-level security policy in a natural language is described in a format readily understandable by humans or in an order readily understandable by humans. When this high-level security policy is converted as it is to a low-level security policy (configuration), the configuration can cause a lower operation efficiency of an associated device. Thus, the method described in JP-2003-140890-A further has a problem of “difficulties in improving the efficiency of an associated device.”

The method and apparatus for managing a firewall described in JP-2000-253066-A generate configuration (firewall configuration file) from an entity relation model generated in a model definition language. Such an entity relation model and firewall configuration file also experience “difficulties in confirming the intention of a security policy creator.”

The configuration may include a setting which dictates prohibition of a certain operation if conditions are not satisfied for a variety of rules that have been previously determined for defining the conditions under which the operation is permitted. On the other hand, some users may wish to describe configuration which includes a setting that dictates permission of a certain operation if conditions are not satisfied for a variety of rules that have been previously determined for defining the conditions under which the operation is prohibited. However, since JP-2000-253066-A fixes an algorithm for generating a configuration file, configuration must be described in one of two description formats. In other words, JP-2000-253066-A lacks for flexibility in format for describing the configuration.

Likewise, the network management system described in JP-2000-244495-A also fixes an algorithm for generating configuration, so that a resulting format for describing the configuration is uniform and therefore lacks for flexibility as is the case with JP-2000-253066-A.

Also, since there is an increasingly strong tendency to practice the security management in accordance with the policy of the ISMS compatibility evaluation regime, enterprises tend to first lay down a security policy. It is therefore preferable to generate configuration for each device based on the security policy. However, the network management system described in JP-2000-244495-A does not generate configuration from a security policy but generates configuration from listed applications.

### SUMMARY OF THE INVENTION

It is an object of the present invention to provide an behavior model generator system and method which are capable of solving the problems of “difficulties in confirming the intention of a security policy creator” and “difficulties in maintaining the consistency” when configuration is generated for a network access controller from a security policy.

It is another object of the present invention to provide an behavior model generator system and method which are capable of solving the problem of “difficulties in improving the efficiency” and capable of describing configuration in a flexible format.

An behavior model generator system according to the present invention is characterized by including policy storing means for storing a security policy including at least a transmission permission condition or a transmission prohibition condition for communicated data, topology storing means for storing topology information which describes information on a device connected to a communication network to which a network access controller is connected for performing at least an operation for permitting the communicated data to transmit or an operation for prohibiting the communicate data from transmitting, and behavior model generating means for generating an behavior model based on the security policy stored in the policy storing means, where the behavior model includes data representative of the operation of the network access controller for each device described in the topology information.

According to the foregoing configuration, the generated behavior model facilitates the confirmation of the intention of a security policy creator. In other words, the behavior model generator system can solve the problem of “difficulties in confirming the intention of a security policy creator.” Further, even if the design guidelines for a security policy differ from one creator to another, the present invention can prevent maintenance operations from being difficult because the intention of each security policy creator is readily confirmed. In other words, the present invention can also solve the problem of “difficulties in maintaining the consistency.”

The behavior model generator system may further include policy input means for entering a security policy, wherein the policy storing means may store a security policy entered through the policy input means.

The behavior model generator system may further include policy normalizing means operable when the security policy does not include a description related to a predefined item for executing normalization for adding a description related to the item to the security policy, wherein the behavior model generating means may be configured to generate an behavior model based on the normalized security policy. According to the foregoing configuration, since the policy normalizing means executes the normalization, an behavior model can be generated from an entered security policy which even includes missing items and/or omitted items.

The behavior model generator system may further include conversion rule storing means for storing a conversion rule for use in converting the behavior model to configuration for defining the operation of the network access controller, described in a format dependent on the type of the network access controller, and configuration generating means for converting the behavior model to the configuration in accordance with the conversion rule. According to the foregoing configuration, the configuration can be generated.

The behavior model generator system may further include modification principle input means for entering a modification principle for an behavior model generated by the behavior model generating means, and modifying means for modifying the behavior model in accordance with the modification principle. According to the foregoing configuration, the behavior model can be modified in accordance with a policy desired by the user.

The behavior model generator system may further include information output means for displaying an image, wherein the modifying means displays a user interface on the information output means for displaying a plurality of candidate modification principles to prompt a user to select a modification principle.

The modifying means may be responsive to a modification principle entered through the modification principle input means to modify an behavior model to delete duplicate information in information included in the behavior model when the modification principle defines that verbosity is not permitted for the behavior model. According to the foregoing configuration, from an behavior model which has been modified in accordance with a policy which defines that redundancy is not permitted for an behavior model, the behavior model generator system can generate configuration in accordance with the same policy.

The behavior model generator system may further include information output means for displaying an image, wherein the modifying means may be configured to display a user interface on the information output means for showing a modification principle which defines that verbosity is not permitted for an behavior model and a modification principle which defines that verbosity is permitted for an behavior model to prompt the user to select one of the modification principles.

The topology storing means may store topology information including information on a software application installed in each device, and the modifying means may be responsive to a modification principle entered through the modification principle input means for modifying an behavior model to delete information other than information related to the software application installed in a device corresponding to the behavior model from information included in the behavior model based on the topology information, when the modification principle defines that strictness is required for the behavior model. According to the foregoing configuration, from an behavior model modified in accordance with a policy which defines that strictness is required for an behavior model, the behavior model generator system can generate configuration in accordance with the same policy.

The behavior model generator system may further include information output means for displaying an image, wherein the modifying means may be configured to display a user interface on the information output means for showing a modification principle which defines that strictness is required for an behavior model, and a modification principle which defines that strictness is not required for an behavior model to prompt the user to select one of the modification principles.

The behavior model generating means may generate, in accordance with the security policy stored in the policy storing means, an behavior model in a first description format which describes that data is permitted to transmit when a transmission permission condition is satisfied and describes that data is prohibited from transmitting when the transmission permission condition is not satisfied, and an behavior model in a second description format which describes that data is prohibited from transmitting when a transmission prohibition condition is satisfied and describes that data is permitted to transmit when the transmission prohibition condition is not satisfied, and the modifying means may be responsive to a modification principle entered through the modification principle input means for modifying the behavior model in the first description format to convert the same to an behavior model in the second description format when the modification principle defines a modification to an behavior model in the second description format, and is responsive to a modification principle entered through the modification principle input means for modifying the behavior model in the second description format to an behavior model in the first description format when the modification principle defines a modification to an behavior model in the first description format. According to the foregoing configuration, the description format of the behavior model can be changed to a description format desired by the user.

The behavior model generator system may further include information output means for displaying an image, wherein the modifying means may be configured to display a user interface on the information output means for showing a modification principle which defines a modification to an behavior model in the second description format, a modification principle which defines a modification to an behavior model in the first description format, and a modification principle which defines that no modification is made to an behavior model to prompt the user to select one of the modification principles.

The modifying means may be responsive to a modification principle entered through the modification principle input means for modifying an behavior model to a form which enables a higher operation of the network access controller when the modification principle defines that the efficiency is required for the operation of a device. According to the foregoing configuration, the configuration can be generated from an behavior model which has been modified in accordance with a policy which defines that the efficiency is required, and the network access controller can be operated at higher speeds with the aid of the configuration. In other words, the behavior model generator system can solve the problem of “difficulties in improving the efficiency.”

The behavior model generator system may further include information output means for displaying an image, wherein the modifying means may be configured to display a user interface on the information output means for displaying a modification principle which defines that the efficiency is required for the operation of a device, and a modification principle which defines that the efficiency is not required for the operation of a device to prompt the user to select one of the modification principles.

The modifying means may be configured to display on the information output means a user interface which displays an behavior model generated by the behavior model generating means as a single diagram. According to the foregoing configuration, the generated behavior model can be presented in a readily understandable way.

The modifying means may be configured to modify an behavior model displayed as a diagram on the user interface in accordance with a modification principle entered through the modification principle input means.

The modifying means may be responsive to a modification principle entered through the modification principle input means and applied to each behavior model which has not been modified, for modifying each behavior model which has not been modified in accordance with the modification principle.

The behavior model generator system may further include information output means for displaying an image, wherein the modifying means may be configured to display a modified behavior model on the information output means as a diagram. According to the foregoing configuration, the generated behavior model can be presented in a readily understandable way.

The behavior model generator system may further include information output means for displaying an image, wherein the behavior model generating means may be configured to display a generated behavior model on the information output means as a diagram.

An behavior model generating method according to the present invention is characterized by including the steps of policy storing means storing a security policy including at least a transmission permission condition or a transmission prohibition condition for communicated data, topology storing means storing topology information which describes information on a device connected to a communication network to which a network access controller is connected for performing at least an operation for permitting the communicated data to transmit or an operation for prohibiting the communicate data from transmitting, and behavior model generating means generating an behavior model based on the security policy stored in the policy storing means, where the behavior model includes data representative of the operation of the network access controller for each device described in the topology information.

A security policy may be entered through policy input means, and the security policy may be stored in policy storing means.

Topology information may be entered through topology information input means, and the topology information may be stored in topology storing means.

The policy normalizing means may execute normalization when the security policy does not include a description related to a predefined item for adding a description related to the item to the security policy, and an behavior model generating means may generate an behavior model based on the normalized security policy.

An behavior model generating program according to the present invention, when run on a computer comprising policy storing means for storing a security policy including at least a transmission permission condition or a transmission prohibition condition for communicated data, and topology storing means for storing topology information which describes information on a device connected to a communication network to which a network access controller is connected for performing at least an operation for permitting the communicated data to transmit or an operation for prohibiting the communicate data from transmitting, is characterized by causing the computer to execute processing for generating an behavior model based on the security policy stored in the policy storing means, where the behavior model includes data representative of the operation of the network access controller for each device described in the topology information.

According to the present invention, the behavior model generator system includes the behavior model generating means for generating an behavior model based on a security policy entered through the policy input means, where the behavior model includes data representative of the operation of the network access controller for each device described in the topology information. The behavior model thus generated facilitates the confirmation of the intention of a security policy creator. In other words, the present invention can solve the problem of “difficulties in confirming the intention of a security policy creator.” Further, even if the design guidelines for a security policy differ from one creator to another, the present invention can prevent maintenance operations from being difficult because the intention of each security policy creator is readily confirmed. In other words, the present invention can also solve the problem of “difficulties in maintaining the consistency.”

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram illustrating an example of an behavior model generator system according to the present invention;

FIG. 2 is a flow chart illustrating an exemplary operation of the behavior model generator system;

FIG. 3 is an explanatory diagram showing an example of an entered security policy;

FIG. 4 is an explanatory diagram showing an example of topology information;

FIG. 5 is an explanatory diagram illustrating an exemplary configuration of a communication network;

FIG. 6 is an explanatory diagram showing examples of predefined values for use in normalization;

FIG. 7 is a flow chart illustrating a procedure for the normalization;

FIG. 8 is an explanatory diagram showing an exemplary result of normalizing a security policy;

FIG. 9 is an explanatory diagram showing an example of an entered security policy;

FIG. 10 is an explanatory diagram showing an exemplary result of normalizing a security policy;

FIG. 11 is an explanatory diagram showing an exemplary behavior model represented in a schematic diagram form;

FIG. 12 is an explanatory diagram showing an exemplary data structure of an behavior model;

FIG. 13 is a flow chart illustrating a procedure for the generation of an behavior model;

FIGS. 14A, 14B are explanatory diagrams showing a state of an behavior model in an behavior model generation process in a tabular and a schematic representation, respectively;

FIGS. 15A, 15B are explanatory diagrams showing a state of the behavior model in the behavior model generation process in a tabular and a schematic representation, respectively;

FIGS. 16A, 16B are explanatory diagrams showing a state of the behavior model in the behavior model generation process in a tabular and a schematic representation, respectively;

FIG. 17 is an explanatory diagram showing an example of a generated behavior model;

FIG. 18 is an explanatory diagram showing an exemplary entry screen for prompting an operator to enter a modification principle for an behavior model;

FIG. 19 is an explanatory diagram showing an example of a modification principle described in XML;

FIG. 20 is a flow chart illustrating a procedure for modifying an behavior model;

FIG. 21 is a flow chart illustrating a procedure for a modification related to verbosity;

FIGS. 22A, 22B are explanatory diagrams showing an exemplary behavior model before a modification related to verbosity in a tabular and a schematic representation, respectively;

FIGS. 23A, 23B are explanatory diagrams showing the exemplary behavior model after the modification related to verbosity in a tabular and a schematic representation, respectively;

FIG. 24 is a flow chart illustrating a procedure for a modification related to strictness;

FIGS. 25A, 25B are explanatory diagrams showing a state of an behavior model in course of the modification related to strictness;

FIGS. 26A, 26B are explanatory diagrams showing a state of the behavior model in course of the modification related to strictness in a tabular and a schematic representation, respectively;

FIGS. 27A, 27B are explanatory diagrams showing an exemplary behavior model after the modification related to strictness in a tabular and a schematic representation, respectively;

FIG. 28 is a flow chart illustrating a procedure for a modification related to default;

FIG. 29 is an explanatory diagram showing a state of an behavior model in course of the modification related to default;

FIG. 30 is an explanatory diagram showing a state of the behavior model in course of the modification related to default;

FIG. 31 is an explanatory diagram showing an exemplary behavior model after the modification related to default;

FIG. 32 is a flow chart illustrating a procedure for a modification related to efficiency;

FIGS. 33A, 33B are explanatory diagrams showing an exemplary behavior model before the modification related to efficiency in a tabular and a schematic representation, respectively;

FIGS. 34A, 34B are explanatory diagrams showing an exemplary behavior model after the modification related to efficiency in a tabular and a schematic representation, respectively;

FIG. 35 is an explanatory diagram illustrating an exemplary GUI which prompts an operator to enter an individual modification principle for each behavior model;

FIG. 36 is an explanatory diagram illustrating an exemplary GUI which prompts an operator to enter an individual modification principle for each behavior model;

FIG. 37 is an explanatory diagram illustrating an exemplary GUI which prompts an operator to enter an individual modification principle for each behavior model;

FIG. 38 is an explanatory diagram showing an exemplary conversion rule;

FIG. 39 is an explanatory diagram showing an exemplary correspondence relationship between indefinite portions determined in a conversion rule and data included in an behavior model;

FIG. 40 is an explanatory diagram showing an example of generated configuration;

FIGS. 41A to 41E are explanatory diagrams showing an exemplary progress of processing from entry of a security policy to reconfiguration of configuration; and

FIGS. 42A to 42D are explanatory diagrams showing another exemplary progress of the reconfiguration of configuration.

### DETAILED DESCRIPTION OF THE PREFERRED EMBODIMENTS

Now, the best mode for practicing the present invention will be described in detail with reference to the accompanying drawings. In the following description, a “policy element” refers to a minimum unit of instructions related to network access control. The instructions related to the network access control include an instruction which permits communicated data (packets) to transmit when conditions are satisfied for permitting the transmission of the data, and an instruction which prohibits communicated data from transmitting when conditions are satisfied for prohibiting the transmission of the data. A “security policy” refers to a set of instructions for the network access control which include zero or more policy elements. A security policy having zero policy element is intended to define nothing for the security policy.

The “security policy” and “policy element” are described, for example, in a natural language or in a format close to a natural format. However, the “security policy” and “policy element” are not necessarily described in a natural language or in a format close to a natural format, but may be described, for example, in XML (extensible Markup Language). The following description will be made giving an example in which the “security policy” and “policy element” are described in a natural language.

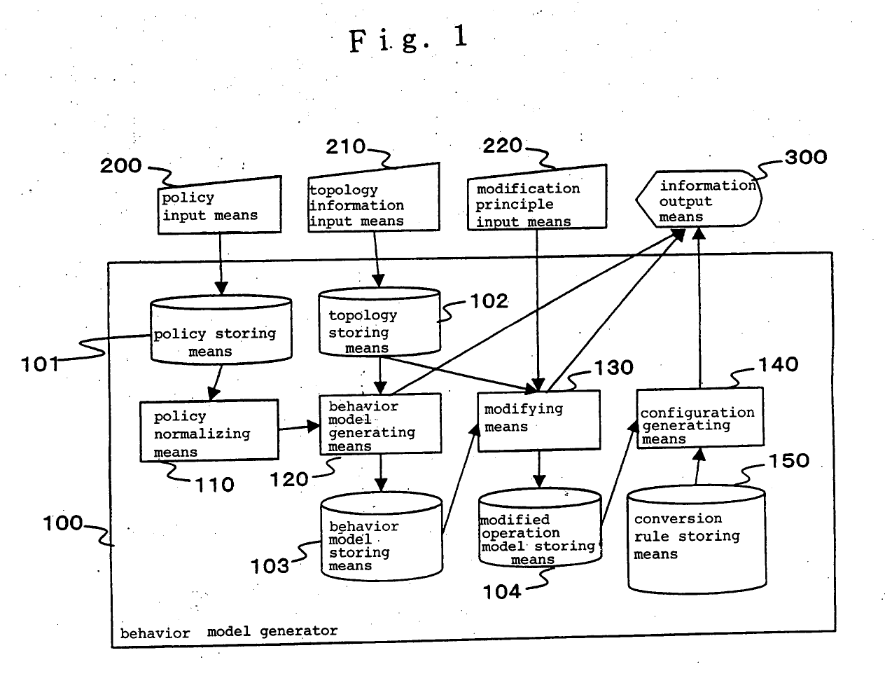

FIG. 1 is a block diagram illustrating an exemplary behavior model generator system according to the present invention. The behavior model generator system illustrated in FIG. 1 comprises behavior model generator 100, policy input means 200, topology information input means 210, modification principle input means 220, and information output means 300.

Behavior model generator 100 may be a computer which runs in accordance with a program.

Policy input means 200 receives a security policy described in a natural language, applied by an operator (system manager or the like). Topology information input means 210 receives topology information applied by the operator. The topology information refers to information indicative of the configuration of a communication network including a network access controller (not shown in FIG. 1), and indicates information on each of zones (parts of the communication network) included in the communication network, information on each hardware component (each device) included in each zone, and information on each software application installed in each hardware component. Modification principle input means 220 receives a modification principle for a generated behavior model, applied by the operator. The behavior model used herein refers to data representative of the operation of the network access controller for each of the devices described in the topology information, or the operation of the network access controller based on that data in a schematic diagram form. A data structure for representing an behavior model will be described later.

The network access controller operates to permit communicated data to transmit or prohibit the communicated data from transmitting.

Policy input means 200, topology information input means 210, and modification principle input means 220 may be any device with which information can be entered. Information is entered in a manner not particularly limited. For example, policy input means 200, topology information input means 210, and modification principle input means 220 may comprise a network interface which receives information through a communication network. Alternatively, policy input means 200, topology information input means 210, and modification principle input means 220 may comprise a driver device (CD-ROM driver or the like) which reads information from a storage medium (for example, CD-ROM or the like) and writes information into a storage medium. Further alternatively, policy input means 200, topology information input means 210, and modification principle input means 220 may comprise a microphone which receives audio information. Also, while FIG. 1 separately shows policy input means 200, topology information input means 210, and modification principle input means 220, a common device (for example, a common keyboard, mouse or the like) may be shared by policy input means 200, topology information input means 210, and modification principle input information 220.

Information output means 300 delivers configuration for the network access controller (not shown in FIG. 1), generated by the behavior model generator. Information output means 300 may be any device which can deliver information. Information is delivered in a manner not particularly limited. For example, information output means 300 may comprise a display device for visually displaying information. Alternatively, information output means 300 may comprise a printer for printing out information. Further alternatively, information output means 300 may comprise a network interface for transmitting information through a communication network. Further alternatively, information output means 300 may comprise a storage medium driver device for writing information into a storage medium. Also, information output means 300 does not necessarily deliver only configuration, but may deliver an behavior model schematically represented by a diagram. The following description will be made giving an example in which information output means 300 is a display device. This display device is assumed to display not only the configuration but also GUI (Graphic User Interface) for the operator to enter information.

Behavior model generator 100 comprises policy storing means 101, topology storing means 102, behavior model storing means 103, modified behavior model storing means 104, conversion rule storing means 150, policy normalizing means 110, behavior model generating means 120, modifying means 130, and configuration generating means 140. Policy storing means 101 is a storage device for storing a security policy entered through policy input means 200. Topology storing means 102 is a storage device for storing topology information entered through topology information input means 210. Behavior model storing means 103 is a storage device for storing a generated behavior model, and modified behavior model storing means 104 is a storage device for storing an behavior model after a modification has been made to an behavior model stored in behavior model storing means 103. A format for the configuration for a network access controller differs from one type to another of the network access controller. Specifically, the configuration defines the operation of a particular network access controller, and is described in a format depending on the type of the network access controller. Conversion rule storing means 150 is a storage device for storing a conversion rule for converting a modified behavior model to configuration described in a format depending on the type of a particular network access controller. While FIG. 1 separately shows policy storing means 101, topology storing means 102, behavior model storing means 103, modified behavior model storing means 104, and conversion rule storing means 150, part or all of these storing means may be implemented by a single storage device.

Policy normalizing means 110 determines whether or not predetermined items are all included in policy elements in a security policy stored in policy storing means 101, and gives a predefined value for any item which is not included in the policy elements. As a result, the predetermined items are all included in each of the policy elements in the security policy. The addition of a predefined value for a predetermined item not included in a policy element to include all the predetermined items in the policy elements is hereinafter called the “normalization.” The normalization of each policy element included in a security policy is expressed by a sentence “a security policy is normalized.” Behavior model generating means 120 generates an behavior model based on a normalized security policy, and stores the generated operation mode in behavior model storing means 103. Modifying means 130 modifies the behavior model in accordance with a modification principle entered through modification principle input means 220, and stores the modified behavior model in modified behavior model storing means 104. Configuration generating means 140 converts the modified behavior model to configuration specific to the network access controller in accordance with the conversion rule stored in conversion rule storing means 150.

Policy normalizing means 110, behavior model creating means 120, modifying means 130, and configuration generating means 140 may be implemented, for example, by a CPU which performs appropriate processing in accordance with a program. Policy normalizing means 110, behavior model generating means 120, modifying means 130, and configuration generating means 140 may be implemented by a single CPU. Also, the program is previously stored in a storage device (which may be the same as any of the storing means illustrated in FIG. 1, or may be a different storage device from the storing means illustrated in FIG. 1) associated with behavior model generator 100.

Next, description will be made on the operation of the behavior model generator system according to this embodiment. FIG. 2 is a flow chart illustrating an exemplary operation of the behavior model generator system in this embodiment.

First, behavior model generator 100 receives a security policy described in a natural language or in a format close to a natural language through policy input means 200 (step S1). In this event, policy storing means 101 stores the received security policy. The storage of the received security policy in policy storing means 101 may be performed, for example, by the CPU (not shown) of behavior model generator 100.

Behavior model generator 100 also receives topology information through topology information input means 210 (step S2). In this event, topology storing means 102 stores the received topology information. The storage of the received topology information in topology storing means 102 may be performed, for example, by the CPU (not shown) of behavior model generator 100. These steps S1, S2 may be executed in a reverse order.

Next, policy normalizing means 110 normalizes the security policy stored in policy storing means 101 (step 3). Specifically, policy normalizing means 101 gives a predefined value for any predetermined item not included in the security policy, so that the security policy includes all predetermined items.

Next, behavior model generating means 120 generates an behavior model using the policy normalized by policy normalizing means 110 and the topology information stored in topology storing means 102 (step S4). Specifically, behavior model generating means 120 generates data representative of the operation of a network access controller in accordance with the entered security policy. Behavior model generating means 120 stores the generated behavior model in behavior model storing means 103. This behavior model is represented by a data structure which is independent of a description dependent on the type of a particular network access controller. Stated another way, the “data structure independent of a description dependent on the type of a particular network access controller” is a data structure which does not depend on the type of any network access controller.

Also, behavior model generating means 120 preferably displays the generated behavior model on information output means 300. In this event, behavior model generating means 120 may display the behavior model in the form of a diagram which schematically represents the operation of the network access controller.

Next, modifying means 130 references the behavior model stored in behavior model storing means 103 to modify the behavior model (step S5). The modified behavior model is represented in the same data structure as the behavior model before the modification. Therefore, the modified behavior model does not either depend on the type of any network access controller. Configuration is generated for the network access controller based on the modified behavior model (step S6, later described).

Also, at step S5, modifying means 130 receives a modification principle for the behavior model through modification principle input means 220. Modifying means 130 modifies the behavior model in accordance with this modification principle. For example, modifying means 130 receives the modification principle for the behavior model, for example, definitions for the following four types of principles. First, modifying means 130 receives a definition as to whether or not verbosity of the behavior model is permitted. Second, modifying means 130 receives a definition as to whether or not strictness is required for the behavior model. Third, modifying means 130 receives a definition related to a default operation in the behavior model. The definition related to a default operation includes “default is permitted,” “default is prohibited,” and “default follows the security policy.” Fourth, modifying means 130 receives a definition as to whether emphasis is placed on the operation efficiency (efficiency) of the network access controller which is provided with the configuration generated from the behavior model.

Upon receipt of a principle which defines that “verbosity is not permitted,” modifying means 130 deletes data such that data contained in the behavior model does not include duplicate data representative of the same operation. Upon receipt of a principle which defines that “verbosity is permitted,” modifying means 130 does not delete duplicate data, if any, representative of the same operation.

Upon receipt of a principle which defines that “strictness is required,” modifying means 130 deletes unnecessary data from the behavior model. Specifically, modifying means 130 determines software applications installed in the network access controller with reference to the topology information. Then, modifying means 130 deletes data representative of operations not related to the software applications from the behavior model. Upon receipt of a principle which defines that “strictness is not required,” modifying means 130 does not delete unnecessary data, if any.

Next described is a modification principle related to default. There are the following two description formats for the behavior model. A first description format describes one or a plurality of data showing that a packet is permitted to transmit when conditions are established for permitting the packet to transmit, and describes that the packet is prohibited from transmitting when the conditions are not established. A second description format describes one or a plurality of data showing that a packet is prohibited from transmitting when conditions are established for prohibiting the packet from transmitting, and describes that the packet is permitted to transmit when the conditions are not established. The default refers to data included in the behavior model which indicates whether or not an operation is permitted or prohibited when any condition is not established. Upon receipt of a principle which defines that “default is prohibited,” modifying means 130 modifies the behavior model such that the behavior model is described in the first description format. Upon receipt of a principle which defines that “default is permitted,” modifying means 130 modifies the behavior model such that the behavior model is described in the second description format. Also, upon receipt of a principle which defines that “default follows the security policy,” modifying means 130 does not modify the description format of the behavior model.

Upon receipt of a principle which defines that “emphasis is placed on efficiency,” modifying means 1300 modifies the behavior model so as to increase the operation efficiency of the network access controller which is provided with configuration generated from the behavior model. For example, assume that a certain network access controller determines whether or not a packet is permitted to transmit at higher speeds (i.e., increase the efficiency of the operation) as the configuration is represented by less descriptions. In this event, modifying means 130 modifies the behavior model to reduce the amount of data included in the behavior model in accordance with the modification principle which defines that “emphasis is placed on efficiency.” upon receipt of a principle which defines that “emphasis is not placed on efficiency,” modifying means 130 does not make such a modification.

Once modifying means 130 has modified the behavior model in accordance with each of received modification principles, the modified behavior model is stored in the modified behavior model storing means 140. In some cases, a received modification principle may indicate that no modification is made to the behavior model. In this event, modifying means 130 stores the same behavior model as that stored in behavior model storing means 103 in modified behavior model storing means 140.

Also, behavior model generating means 120 preferably displays the modified behavior model on information output means 300. In this event, behavior model generating means 120 may display the behavior model in the form of a diagram which schematically represents the operation of the network access controller. The following description will be made on the assumption that the behavior model before a modification is displayed at step S4, and the modified behavior model is displayed at step S5.

Next, configuration generating means 140 generates configuration by converting the modified behavior model stored in modified behavior model storing means 104 (step S6). In this event, configuration generating means 140 converts the behavior model in accordance with the conversion rule stored in conversion rule storing means 150. The configuration generated at step S6 is described in a format which depends on the type of a particular network access controller. Also, configuration generating means 140 displays the generated configuration on information output means 300.

The operator such as a system manager or the like may set the operation of the network access controller using the configuration generated at step S6. As a result, the network access controller operates in accordance with the security policy entered through policy input means 200.

Next, the operation of the behavior model generator will be described in greater detail with reference to specific examples of a variety of information applied thereto.

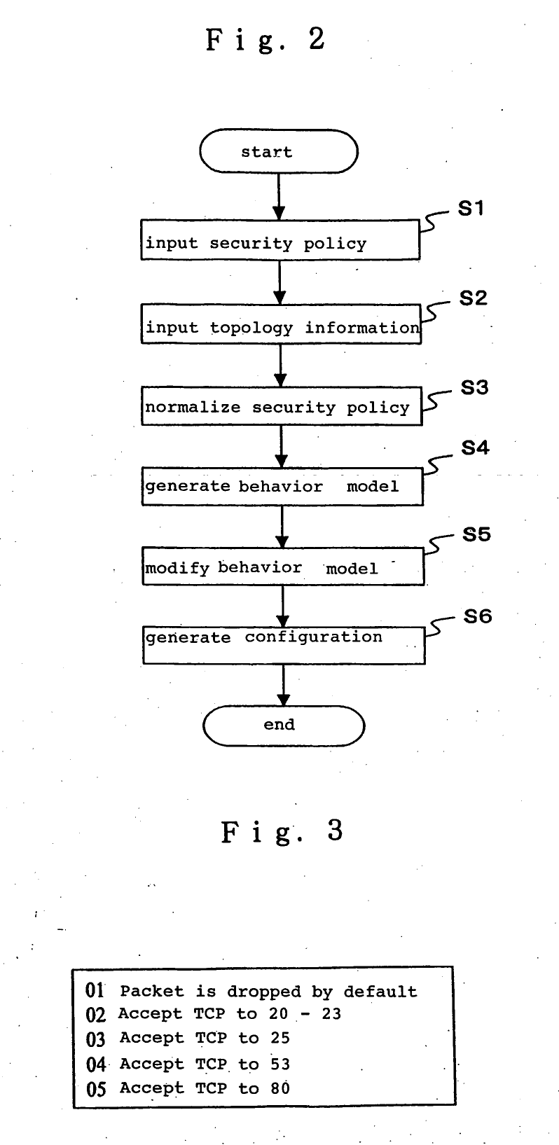

FIG. 3 shows an exemplary security policy entered through policy input means 200. As shown in FIG. 3, the security policy is described in a simple natural language. In the example shown in FIG. 3, each of 01 to 05 lines serves as a policy element. In other words, the security policy exemplified in FIG. 3 includes five policy elements. The policy element on the 01 line is applied in regard to the network access control when a transmitted packet does not satisfy conditions defined by the other policy elements (policy elements on the 02 to 05 lines). In other words, the 01 line contains a policy element which defines a default. The policy element on the 01 line exemplified in FIG. 3 represents that none of transmitted packets which do not satisfy the conditions defined by the other policy elements are permitted to transmit. Not permitting a packet to transmit is expressed by “Drop.”

The policy element on the 02 line exemplified in FIG. 3 represents that a packet is permitted to transmit if the packet is in accordance with TCP (Transmission Control Protocol) and is destined to port numbers 20-23. Permitting a packet to transmit is expressed by “Accept.” Here, the port number will be described. The port number is a number assigned for each type of network services, and ranges from 1 to 65535. Port number 20 is used for transferring data for an FTP service. Port number 21 is used for controlling the FTP service. Port number 22 is used for an SSH service. Port number 23 is used for a TELNET service. In other words, the policy element on the 02 line represents that a packet is permitted to transmit when it is involved in the FTP service, SSH service, or TELNET service.

Likewise, the policy elements on the 03 to 05 lines exemplified in FIG. 3 each represent that a packet is permitted to transmit if the packet is in accordance with TCP (Transmission Control Protocol) and is destined to a predetermined port number. Port number 25 described in the 03 line is used in an SMTP (Simple Mail Transfer Protocol: protocol for Internet mail) service. Port number 53 is used in a DNS (Domain Name System: solution of Internet domain name) service. Port number 80 is used in an HTTP (Hypertext Transfer Protocol: transmission/reception of information in WWW) service.

While the security policy exemplified in FIG. 3 is described in a natural language, the security policy need not be described in a natural language, as previously mentioned. For example, a received security policy may be described in XML.

At step S1, behavior model generator 100 receives a security policy as exemplified in FIG. 3 through policy input means 200. The security policy may be entered in a manner not limited, as previously described. Policy input means 200 may be an input device such as a keyboard, a mouse or the like, and the security policy may be entered through such an input device. Alternatively, policy input means 200 may be a driver device for reading information from a storage medium, and read a security policy stored in the storage medium in the form of a file. Further alternatively, a set of policy elements previously stored in a storage device may be displayed on information output means 300, such that policy elements selected by a mouse or the like may be entered as a security policy. Policy input means 200 may be a microphone, in which case an audibly generated security policy may be entered through the microphone. Policy storing means 101 stores a security policy entered through policy input means 200.

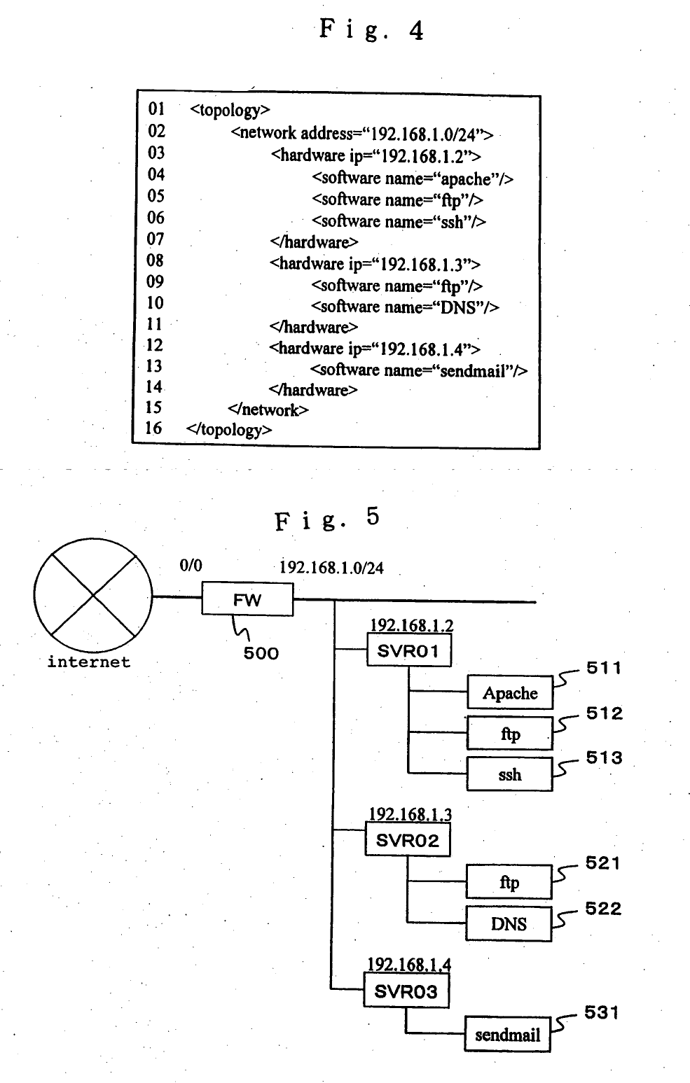

FIG. 4 shows exemplary topology information entered through topology information input means 210. FIG. 5 in turn illustrates an exemplary configuration of a communication network. The topology information exemplified in FIG. 4 shows the configuration of the communication network illustrated in FIG. 5. Also, as shown in FIG. 4, the topology information is described, for example, in XML.

In the communication network illustrated in FIG. 5, an Internet zone (0/0 network) is separated from a communication network (192.168.1.0/24 network), which is to be managed, by firewall 500. A communication network is identified by a network address (for example, an IP address) using a net mask. Specifically, a communication network is represented as a set of network addresses in a range from a network address which has fixed bits, equal in the number to the net mask (value next to “/”), from the most significant bit, with the remaining bits being set at “0,” to a like network address which has the remaining bits all set at “1.” Network devices SVR01, SVR02, SVR03 are connected to the communication network (192.168.10/24) to be managed. The network devices may be a server computer or a personal computer, or an appliance device. In this embodiment, the network devices are server computers in which Linux (the name of an operating system) is installed.

Assume that SVR01 is assigned a network address “192.168.1.2”; SVR02 is assigned a network address “192.168.1.3”; and SVR03 is assigned a network address “192.168.1.4.” Also, in the example illustrated in FIG. 5, server computer SVR01 is installed with Appache 511 which is a WWW (World Wide Web) server software application; ftp 512 which is an FTP server software application; and ssh 513 which is a secure shell software application. Server computer SVR02 is installed with ftp 521 which is an FTP server software application; and DNS 522 which is a name server software application. Server computer SVR03 is installed with sendmail 531 which is a mail server software application.

The topology information exemplified in FIG. 4 describes the configuration of the communication network illustrated in FIG. 5, particularly, the configuration of the communication network (192.168.1.0/24) which is to be managed. In the example shown in FIG. 4, a communication network identified by a network address “193.168.1.0/24” is described in a portion sandwiched by network tags. Each hardware component identified by a network address is described together with its hardware tag. Also, each hardware tag is described in a range sandwiched by the network tags, and shows that each hardware component is included in the communication network. Each application software is described together with a software tag. Each software tag is described within a range sandwiched by hardware tags associated therewith, and shows that each application software is installed in the hardware component.

While the topology information exemplified in FIG. 4 is described in XML, it may not be described in XML. For example, the topology information may be described as data of a CAD software application representative of the configuration of the communication network. Alternatively, the topology information may be described in a natural language. The data of the CAD software application may be, for example, data which draws the configuration of the communication network illustrated in FIG. 5.

At step S2, behavior model generator 100 receives topology information as exemplified in FIG. 4 through topology information input means 210. The topology information may be entered in a manner not particularly limited. Topology information input means 210 may be an input device such as a keyboard, a mouse, or the like through which the topology information may be entered. Alternatively, topology information input means 210 may be a driver device for reading information from a storage medium, in which case a data file of the CAD software application stored in a storage medium may be read as topology information. Further alternatively, when the configuration of the communication network illustrated in FIG. 5 is drawn by an input device such as a mouse, data on the drawn communication network may be entered as topology information. Topology information input means 210 may be a microphone, in which case audibly generated topology information may be entered through the microphone. Topology storing means 102 stores the topology information entered through topology information input means 210.

Next described is the normalization at step S3. A policy element which defines the operation of a network access controller needs at least seven items of information. For defining the operation of a network access controller, each policy element needs the following seven items of information: whether the policy element specifies a “default” operation; where is a “source address”; which number a “source port” has; where is a “destination address”; which number a “destination port” has; which “protocol” is employed; and “action” (whether or not a packet is permitted to transmit). However, when a security policy is described in a natural language, it is often the case that portions which can be omitted are not described. For example, in the example shown in FIG. 3, items on “source address” and the like are omitted as mentioned. Policy normalizing means 110 determines whether or not the foregoing seven items are described in each of policy elements in the security policy stored in policy storing means 101, and gives a predefined value for an item which is not described. This processing is the normalization.

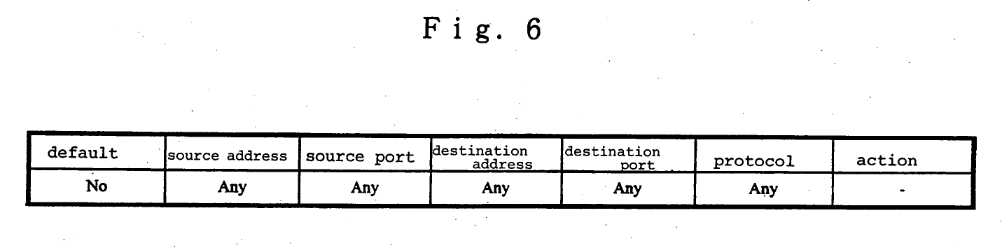

FIG. 6 shows examples of such predefined values for the respective items. In the example shown in FIG. 6, when no description is given in an item which indicates whether or not a policy element specifies a “default” operation, a predefined value “No” is given to this item. Specifically, information given herein shows that “this is not a policy element which specifies a default operation.” When descriptions are missing in the respective items “source address,” “source port,” “destination address,” “destination port,” and “protocol,” “any” is given to each of these items. “Any” means that any value may be taken. However, “action” is described by a policy element without fail. For this reason, no predefined value is provided for “action.” The predefined values exemplified in FIG. 6 may be previously stored in a storage device associated with behavior model generator 100 (which may be the same as any of the storing means illustrated in FIG. 1, or may be a different storage device from the storing means illustrated in FIG. 1).

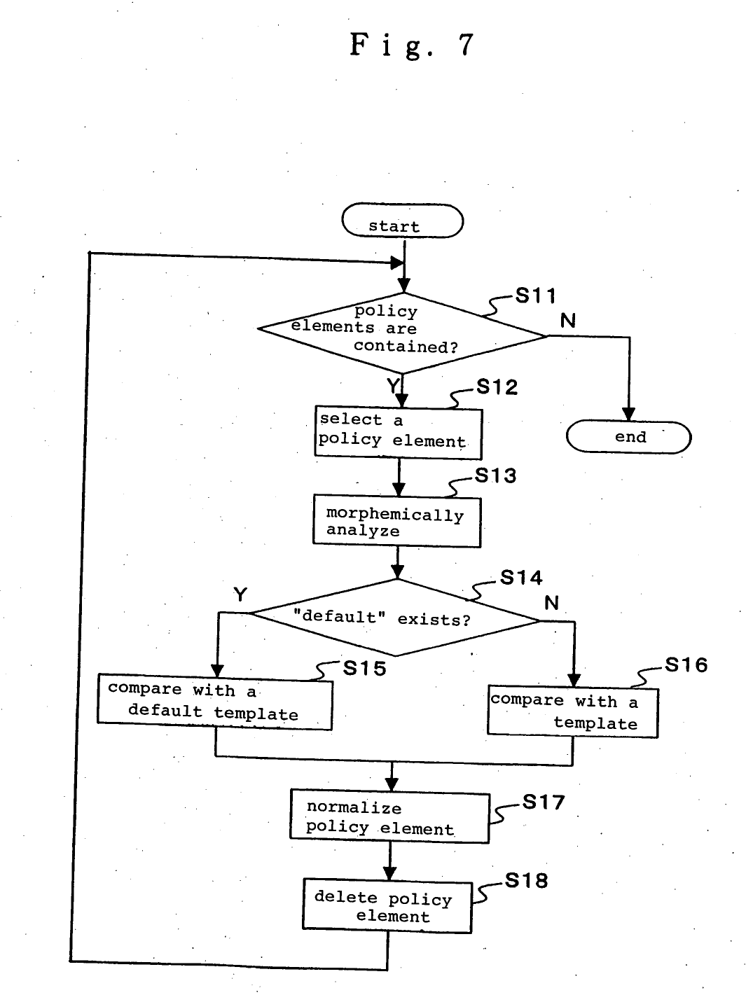

FIG. 7 is a flow chart illustrating a procedure for the normalization (step S3) performed by policy normalizing means 110. First, policy normalizing means 110 determines whether or not policy elements are contained in the security policy stored in policy storing means 101 (step S11). If there is no policy element in the security policy, the normalization procedure is terminated. Conversely, when policy elements are found, policy normalizing means 110 selects a policy element from the security policy stored in policy storing means 101 (step S12). Subsequently, policy normalizing means 110 morphemically analyzes the selected policy element for decomposition into morphemes (step S13).

Policy normalizing means 110 determines whether or not a word “default” exists in the decomposed morphemes (step S14). If the word “default” is found in the morphemes (Y at step S15), policy normalizing means 110 compares the policy element morphemically analyzed at step S13 with a default template (step S15). A “template” refers to a sentence representative of a policy element which includes indefinite items. The “default template” refers to a sentence which represents a policy element that specifies a default, and has an indefinite item corresponding to the action. In this example, assume that the default template is a sentence which states that “$action is made by default.” Behavior model generator 100 has stored a variety of templates in a storage device. While the foregoing template-based operation is described in this embodiment, behavior model generator 100 may have previously stored a plurality of types of default templates, and compare a policy element with the plurality of default templates at step S15.

This embodiment is described in connection with an example in which a symbol “$” is used to indicate an indefinite variable portion in a template, but the symbol indicative of an indefinite variable portion need not be “$.”

In the exemplified default template, the “$action” is a variable, indicating that the action is indefinite. At step 13, assume that policy normalizing means 110 morphemically analyzes a policy element on the 01 line shown in FIG. 3. In this event, the morphemic analysis results in morphemes which are decomposed into “Packet, Is, Dropped, By default.” The result of the morphemic analysis is compared with the default template “$action is made by default” to identify a morpheme which corresponds to the indefinite “$action,” thereby revealing that “$action” is “Drop.” In other words, this comparison can identify the item of “action” in the policy element which specifies a default. When the word “default” is found in the result of the morphemic analysis, it is possible to identify the policy element which specifies the “default” operation. As a result, it can be determined at the end of the comparison at step S15 that the policy element on the 01 line shown in FIG. 3 does not include the items “source address,” “source port,” “destination address,” “destination port,” and “protocol.” Policy normalizing means 110 sets the predefined value shown in FIG. 6 (“any” for each item) to each of these items after the comparison at step S15 to normalize the policy element on the 01 line show in FIG. 3.

At step S14, if the word “default” is not found in the morphemes (N at step S14), the policy element morphemically analyzed at step S13 is compared with the template (step S16). At step S16 the default template is replaced by a template which is applied to policy elements other than the policy element which specifies a default. In this example, assume that a template used herein describes that “$protocol performs $action from $source port at $source address to $destination port at $destination address.” Assume also that, at step S13, policy normalizing means 110 has morphemically analyzed the policy element on the 02 line in FIG. 3, i.e., “Accept TCP to 20-23.” In this event, the result of the morphemic analysis shows “Accepts, TCP, to, 20-23.” Policy normalizing means 110 compares the result of the morphemic analysis with the template which states that “$protocol performs $action from $source port at $source address to $destination port at $destination address.” Through this comparison, policy normalizing means 110 identifies whether or not this policy element specifies a “default” operation, and also identifies items which can be identified from among “source address,” “source port,” “destination address,” “destination port,” “protocol,” and “action.” It should be noted that policy normalizing means 110 compares the variable with the result of the morphemic analysis on the assumption that “$source address” and “$destination address” are in address notation such as “XXX. XXX. XXX. XXX” or “XXX. XXX. XXX. XXX/XX” (X represents a numerical value), and “$source port” and “$destination port” are in port notation such as “XX” or “XX-XX” (X represents a numerical value).

When the result of the morphemic analysis on the policy element on the 02 line shown in FIG. 3 is compared with the template which states that “$protocol performs $action from $source port at $source address to $destination port at $destination address,” it can be determined that “$destination port” is “20-23”; “$protocol” is “TCP”; and “$action” is “Accept.” It can be determined that there are no corresponding values in the morphemes for the other items (“$source address,” “$source port,” “$destination address” and the like).

Subsequent to step S16, policy normalizing means 110 gives the predefined values to the items for which corresponding values are not found in the morphemes to normalize the policy element (step S17). In the exemplary policy element on the 02 line in FIG. 3, the morphemes resulting from the morphemic analysis do not include a morpheme (word “default”) which indicates a policy element that specifies the “default” operation. Therefore, policy normalizing means 110 applies a predefined value “No” shown in FIG. 6 to the item indicating whether or not the associated policy element specifies a “default” operation. Also, policy normalizing means 110 applies the predefined value “any” shown in FIG. 6 to “$source address,” “$source port,” and “$destination address” for which values are not identified in the comparison at step S16.

After normalizing the policy element at step S17, policy normalizing means 110 deletes the policy element selected at step S12 from the security policy (step S18). Then, policy normalizing means 110 repeats the processing at step S11 onward. Also, when policy normalizing means 110 determines that there is no remaining policy element (N at step S11) and terminates the normalization, policy normalizing means 110 sends the normalized security policy to behavior model generating means 120.

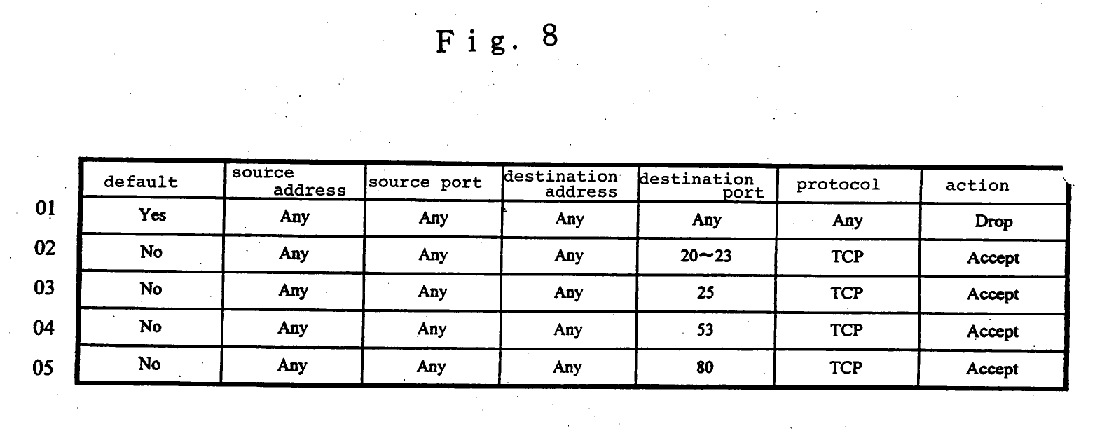

FIG. 8 shows an exemplary result of normalizing the security policy. Each of policy elements on 01 to 05 lines shown in FIG. 8 is a normalized version of each of the policy elements on the 01 to 05 lines shown in FIG. 3, respectively. Since the policy element on the 01 line shown in FIG. 3 includes the word “default” as a morpheme, the item labeled “default” shown in FIG. 8 contains “Yes” indicative of a policy element which specifies the default operation. “Action” in turn is determined to be “Drop” from the 01 line of FIG. 3. Since the remaining items are not described on the 01 line shown in FIG. 3, the predefined value (any for all the items) is given thereto by policy normalizing means 110.

The policy element on the 02 line shown in FIG. 3 does not include the word “default” as a morpheme. Therefore, policy normalizing means 110 gives the predefined value “No” to the item “default” shown in FIG. 8. Also, through the comparison (at step S16) made by policy normalizing means 110, “destination port,” “protocol,” and “action” are determined to be “20-23,” “TCP,” and “Accept,” respectively. Since the remaining items are not described on the 02 line shown in FIG. 3, the predefined value (“any” for all the items) is applied thereto by policy normalizing means 110.

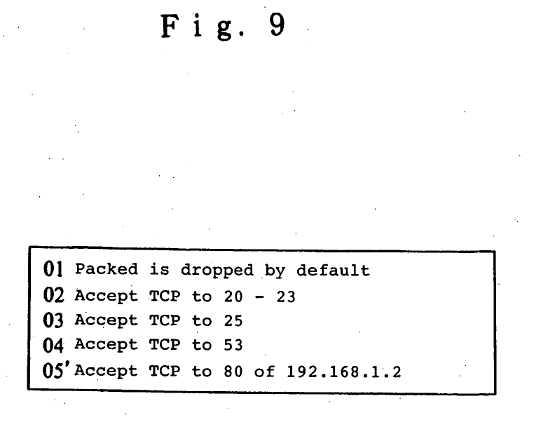

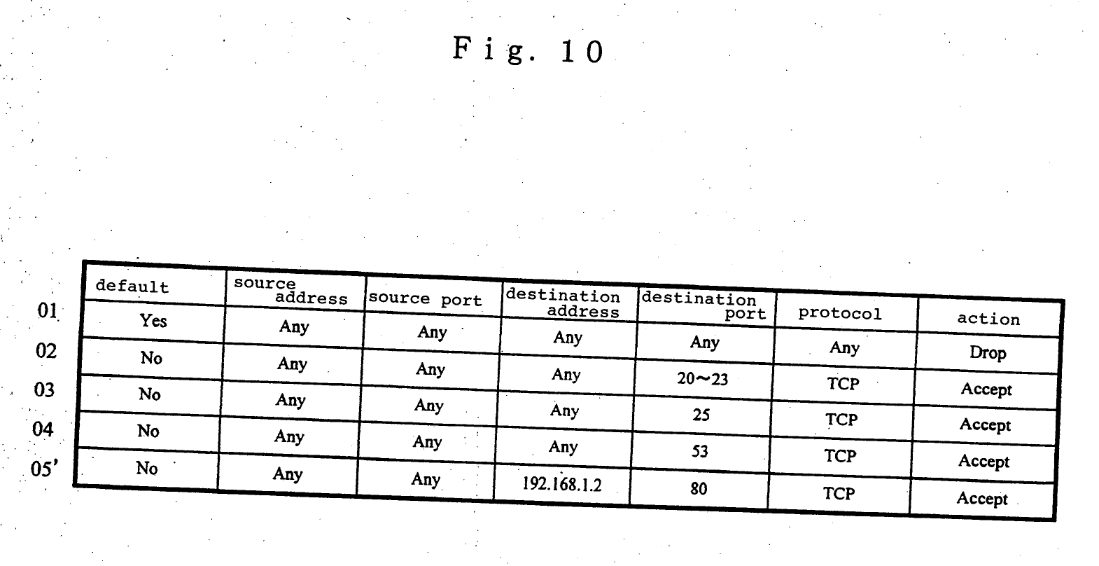

Another example will be shown for the normalization of a security policy. A security policy shown in FIG. 9 has a change to the policy element on the 05 line of the security policy shown in FIG. 3. FIG. 10 shows the result of normalizing the security policy shown in FIG. 9. A comparison of the fifth line shown in FIG. 3 with a 05′ line in FIG. 9 reveals the addition of a phrase “of 192.168.1.2.” Therefore, two morphemes “193.168.1.2.” and “of” increase in the result of the morphemic analysis. As a result, policy normalizing means 110 determines through a comparison with the template, that the source address is “193.168.1.2,” so that “193.168.1.2” is substituted for the predefined value shown in FIG. 6 in the destination address. As result, the normalized security policy is as shown in FIG. 10. It should be understood that the normalized policy elements on 01 to 04 lines are the same as those in FIG. 8.

While the foregoing embodiment has been described in connection with the normalization of policy elements using the result of morphemic analysis and template, the normalization of policy elements is not limited to this method. Policy normalizing means 110 may be configured to normalize policy elements by a plurality of types of methods of normalizing policy elements. In this event, even if a security policy is described in a variety of Japanese notations, the security policy can be normalized. Stated another way, the policy normalizing means 110 can support security policies in a variety of different notations.

Next described is the generation of an behavior model at step S4. As previously described, the behavior model comprises a set of data representing the operation of a network access controller, or a schematic diagram representing the operation of the network access controller based on that data. One behavior model is associated with each network device. For example, behavior models of firewall 500 shown in FIG. 5 include an behavior model for SVR01, an behavior model for SVR02, and an behavior model for SVR03. If other network devices are installed in addition to SVR01, SVR02, SVR03, firewall 500 also has behavior models associated with such network devices. In this way, behavior models are associated with all network devices indicated by topology information. A set of behavior models associated with the respective network devices is called a “full behavior model.”

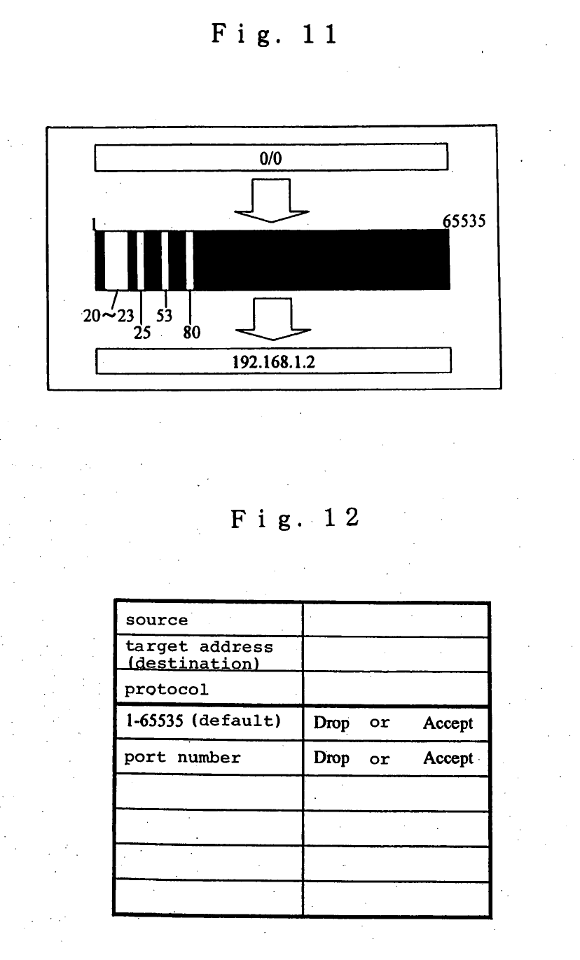

FIG. 11 shows an behavior model associated with network device SSVR01 (see FIG. 5) which has a network address “193.168.1.2.” As shown in FIG. 11, an behavior model represented in a schematic diagram form includes an area indicative of a source, an area indicative of a destination, and an area indicative of an access control state between these areas. Then, the area indicative of the access control state corresponds to port numbers 1-65535 of the destination. In FIG. 11, the operation of firewall 500 shown in FIG. 5 shows that among packets transmitted to “193.168.1.2,” those having a destination port number 20-23, 25, 53 or 80 are permitted to transmit, and the remaining packets are prohibited from transmitting irrespective of the source address. Similar behavior models are generated for SVR02 and SVR03 shown in FIG. 5, and a set of these behavior models make up a full behavior model.

FIG. 12 is an explanatory diagram showing an exemplary data structure for the behavior model shown in FIG. 11. As shown in FIG. 12, the data structure for the behavior model includes “source,” “target address (destination),” “protocol,” “1-65535 (default),” “port number” specified by a policy element other than a policy element which specifies a default, and an associated operation. A source address is set for the value of “source” in the data structure shown in FIG. 12. A protocol such as TCP, UDP (User Datagram Protocol) or the like is set for the value of “protocol” in the data structure. “1-65535 (default)” shown in FIG. 12 represents a default operation for each of destination port numbers 1-65535. Either “Drop (packet prohibited from transmitting)” or “Accept (packet permitted to transmit)” is determined for “1-65535 (default).” Determined for “port number” is the value of each destination port number on an individual basis. Also, “Drop” or “Accept” is determined for the operation at that “port number.”

When a destination port number in a transmitted packet does not match “port number” shown in FIG. 12, the packet is permitted to transmit or prohibited from transmitting in accordance with “1-65535 (default).”

FIG. 11 shows the behavior model represented by the data structure shown in FIG. 12 in a schematic diagram form. The behavior model represented in a schematic diagram form as in FIG. 11 is displayed on information output means 300.

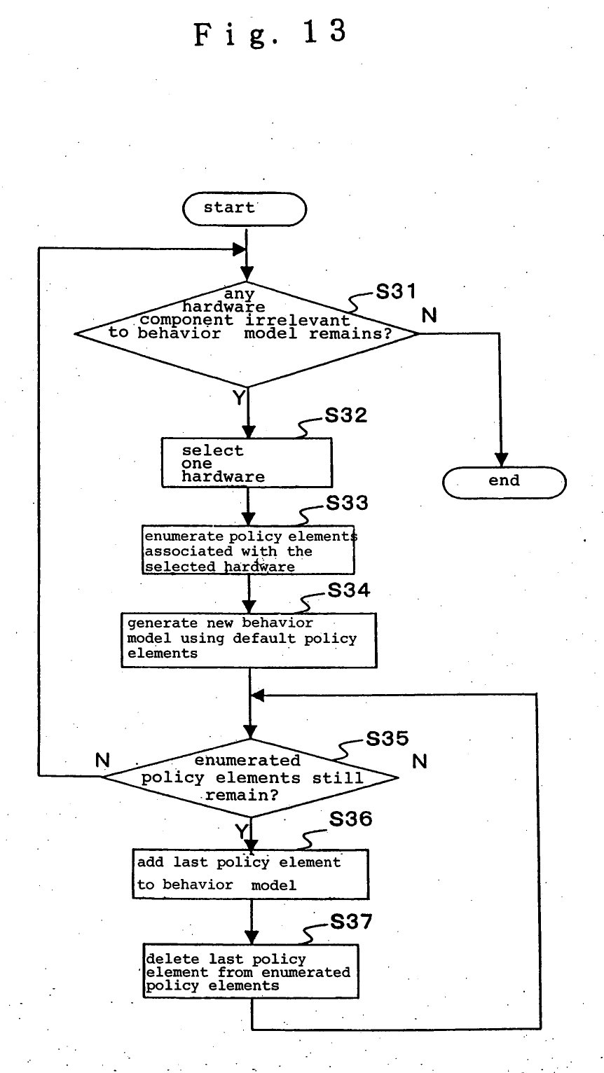

FIG. 13 is a flow chart illustrating a procedure for the generation of an behavior model (step S4) by behavior model generating means 120. At the start of the procedure for the generation of an behavior model, topology storing means 102 has stored topology information. Also, behavior model generating means 120 has been previously supplied with a normalized security policy from policy normalizing means 110. Assume herein that the normalized security policy shown in FIG. 8 has been supplied to behavior model generating means 120.

Behavior model generating means 120 determines whether or not any hardware component irrelevant to an behavior model remains in the topology information stored in topology storing means 102 (step S31). Specifically, within hardware components shown in the topology information, behavior model generating means 120 determines whether or not the topology information still includes any hardware component for which no behavior model has been generated after a selection of hardware components which are involved in the operation of the network access controller. If there is no such hardware component left in the topology information, behavior model generating means 120 terminates the behavior model generation.

Conversely, if the topology information still includes hardware components which have not been selected (Y at step S31), behavior model generating means 120 selects one from the remaining hardware components (step S32). For example, assume that behavior model generating means 120 generates an behavior model using the topology information shown in FIG. 4 (corresponding to the configuration illustrated in FIG. 5). The topology information shown in FIG. 4 indicates that there are three network devices (SVR01, SVR02, SVR03 shown in FIG. 5) present in the network represented by “193.168.1.0/24.” First, when the procedure goes to step S31, behavior model generating means 120 has not selected any hardware component, causing the procedure to go to step S32. At step S32, behavior model generating means 120 selects, for example, data on the first device (data corresponding to SVR01).

Next, behavior model generating means 120 enumerates policy elements associated with the device selected at step S32 (step S33). The policy elements associated with the selected device are those which include the network address of the selected device in the destination address. Assume that the device selected at step S32 has a network address “193.168.1.2.” Also, “any” is set in the destination address of each of the policy elements in the entered security policy (in this example, the security policy shown in FIG. 8). Thus, “193.168.1.2” is included in the destination address of each policy element. As such, behavior model generating means 120 enumerates all the policy elements shown in FIG. 8 because they are associated with the selected device.

The enumeration of policy elements, used herein, involves, for example, extracting the policy elements from the security policy in order, arranging the policy elements in the order in which they have been extracted, and temporarily storing a sequence of the ordered policy elements in a storage area.

Suppose that the security policy shown in FIG. 10 has been supplied to behavior model generating means 120. Suppose also that the data on the device selected at step S32 matches the data on SVR02. In this event, the network address of the selected hardware component indicates “193.168.1.3.” On the other hand, the destination address of the policy element on 05′ line shown in FIG. 10 indicates “193.168.1.2.” Therefore, in this scenario, the policy element on the 05′ line shown in FIG. 10 does not fall under policy elements associated with the selected device, so that behavior model generating means 120 enumerates the policy elements on the 01 line to 04 lines shown in FIG. 10.

At step S32, behavior model generating means 120 determines from the 01 line in order whether or not the policy element is associated with the selected hardware component, and enumerates the policy elements if it is associated with the selected hardware component (extracts the policy element for temporary storage in a storage area). When behavior model generating means 120 extracts another policy element associated with the selected hardware component, this policy element is temporarily stored in the storage area next to the previously enumerated policy element. In this way, behavior model generating means 120 orders the respective policy elements associated with the selected hardware component. However, there is only one policy element which specifies a default operation (the 01 line in the example shown in FIG. 8), which is distinguished from other policy elements. Therefore, the policy element which specifies a default operation may be positioned at an arbitrary turn. In the examples shown in FIG. 8 and 10, the policy element on the 01 line specifies a default operation. When the policy element on the 01 line is determined to specify a default operation, the policy element on the 01 line may be unconditionally determined to be a policy element associated with a selected hardware component without confirming its destination address.

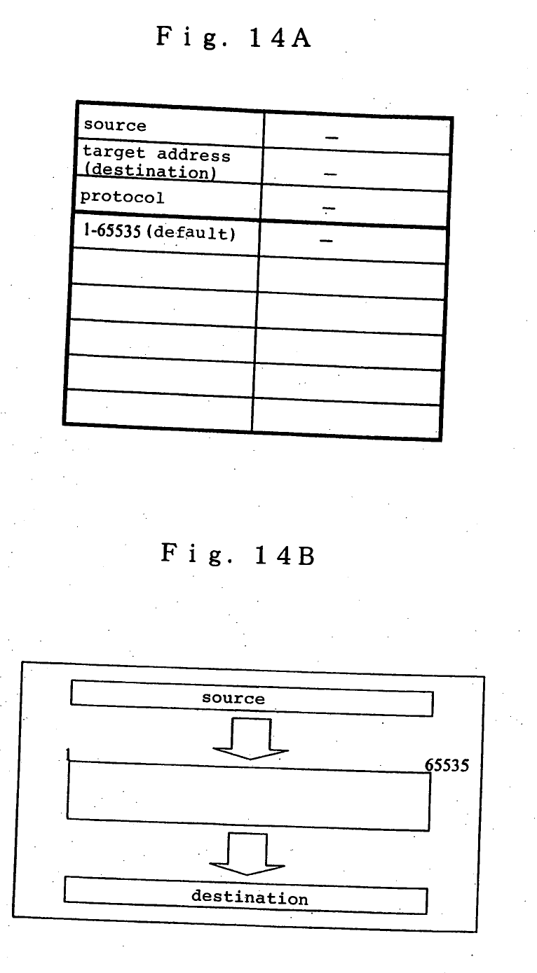

Next to step S33, behavior model generating means 120 generates a new behavior model, and initializes the behavior model using the policy element which specifies a default operation within the policy elements enumerated at step S33 (step S34). Behavior model generating means 120 generates data shown in FIG. 14A for the new behavior model. The data shown in FIG. 14A include indefinite data in the data structure shown in FIG. 12. The behavior model shown in FIG. 14A can be represented in a schematic diagram form as shown in FIG. 14B. In FIG. 14B, the schematic diagram does not clarify either the destination address or source address, and does not either clarify the destination port number of a packet which is permitted to transmit.

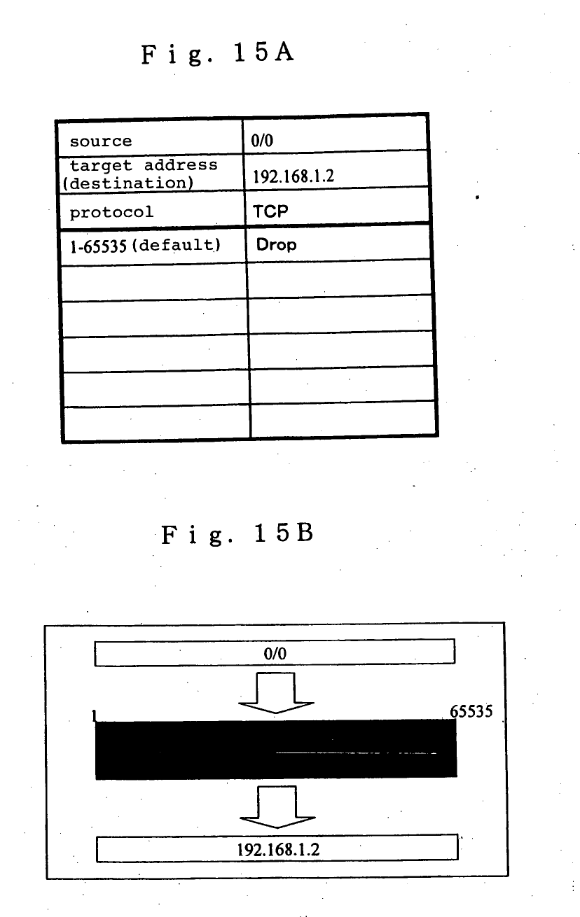

The new behavior model shown in FIG. 14A may be initialized to create an behavior model shown in FIG. 15A. The initialization of the behavior model involves the use of the policy element which specifies a default operation. In the security policy shown in FIG. 8, the content specified as a default is “Drop.” Accordingly, behavior model generating means 120 determines data of “1-65535 (default)” in the data structure shown in FIG. 12 to be “Drop.” Also, behavior model generating means 120 determines “source” and “protocol” in the data structure to be “0/0” (the same as “any” in meaning) and “TCP,” respectively, in accordance with the policy element (see the 01 line in FIG. 8) which specifies a default operation. Also, behavior model generating means 120 sets the network address of the hardware component selected at step S32 (assume herein “193.168.1.2”) to the value of “target address (destination).”

The behavior model shown in FIG. 15A can be represented in a schematic diagram form as shown in FIG. 15B. In FIG. 15B, since the data in “1-65535 (default)” has been determined to be “Drop” during the initialization, all the range of destination port numbers 1-65535 is shown in black for indicating “Drop” (packet prohibited from transmitting).

After the initialization of an behavior model, behavior model generating means 120 deletes the policy element used for the initialization (policy element which specifies a default operation) from the enumerated policy elements. At step S33, the policy element which specifies a default operation may not be included in the policy elements enumerated at step S33, but may be temporarily stored separately from the enumerated policy elements. In any case, after step S34 has been executed, the policy element which specifies a default operation is not included in the enumerated policy elements.

Next to step S33, behavior model generating means 120 determines whether or not the enumerated policy elements still remain (step S35). When the enumerated policy elements have been all deleted and therefore do not remain (N at step S35), behavior model generating means 120 repeats the processing at step S31 onward.

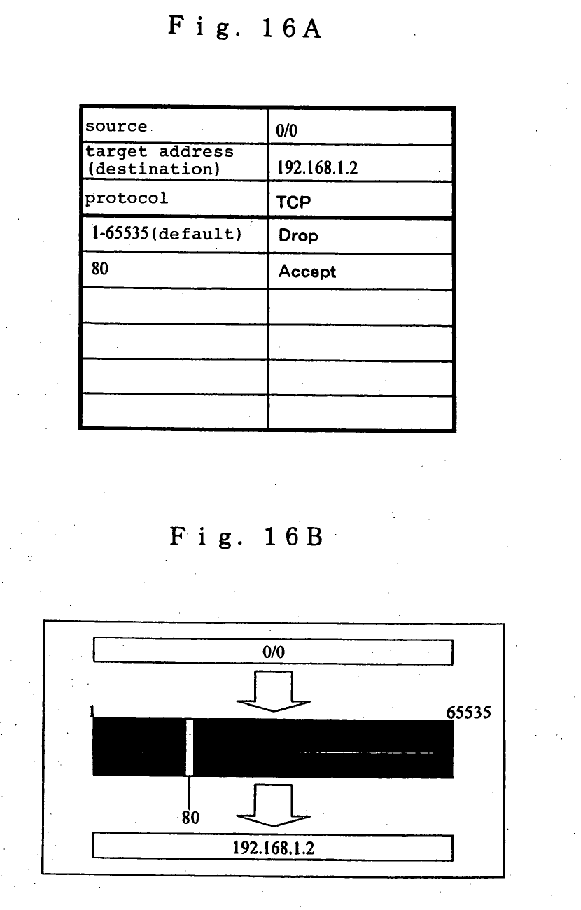

When any of the enumerated policy elements still remains (Y at step S35), behavior model generating means 120 adds the contents represented by the last policy element of the enumerated policy elements to the behavior model (step S36). In this example, behavior model generating means 120 enumerates the policy elements in the security policy shown in FIG. 8. When the procedure first goes to step S36, the last policy element is present on the 05 line shown in FIG. 8. Since the contents of the policy element on the 05 line means that a packet is permitted to transmit (Accept) when a destination port is 80, “Accept” (transmission permitted) is assigned to the port number 80 in the behavior model. This results in the behavior model changed as shown in FIG. 16A. In addition, the behavior model shown in FIG. 16A can be represented in a schematic diagram form as shown in FIG. 16B. In FIG. 16B, an area corresponding to destination port number 80 is shown in white for indicating “Accept” (transmission permitted).

After step S36, behavior model generating means 120 deletes the policy element, the contents of which have been added to the behavior model at step S36 (step S37). Specifically, behavior model generating means 120 deletes the last policy element of the enumerated policy elements. Subsequently, behavior model generating means 120 repeats the processing at step S35 onward. As the processing at steps S35 to S37 is repeated, the policy elements on the 04 line, 03 line, 02 line are placed one by one at the last policy element, and their contents are added to the behavior model. FIG. 17 shows the behavior model at the time the contents of the policy element on the 02 line have been added to the behavior model, and the enumerated policy elements have been all deleted. The behavior model shown in FIG. 17 can be represented in a schematic diagram form as shown in FIG. 11.

As the procedure returns to step S31 after executing the processing at steps S32 to S37 for each of the hardware components described in the topology information, behavior model generating means 120 determines that there is no hardware component which has not been selected as involved in the operation of the network access controller, and terminates the behavior model generation. As a result, the behavior model as shown in FIG. 17 (FIG. 11 when represented in a schematic diagram form) is generated for each hardware component (network device). In other words, a full behavior model is generated. Upon termination of the behavior model generation, behavior model generating means 120 stores the generated full behavior model in behavior model storing means 103. Behavior model generating means 120 also displays the respective behavior models on information output means 300. In this event, the behavior models are displayed in a schematic diagram form as exemplified in FIG. 11.

The foregoing embodiment has been described in connection with a security policy in which the individual policy elements specify TCP for the protocol by way of example. Even when the policy element specifies UDP, the behavior model is consistent in the data structure itself, and can be represented in a schematic diagram form similar to that illustrated in FIG. 11 or the like.

Next described are modification principles entered through modification principle input means 220. FIG. 18 is an exemplary input screen for prompting the operator to enter modification principles. Modifying means 130 displays the input screen illustrated in FIG. 18 on information output means 300 to prompt the operator to enter a modification principle for an behavior model related to verbosity, a modification principle for an behavior model related to strictness, a modification principle for an behavior model related to default, and a modification principle for an behavior model related to efficiency. FIG. 18 shows that the operator has entered modification principles as follows: “verbosity is permitted,” “strictness is not required,” “default follows the policy,” and “emphasis is not placed on the efficiency.” The combined modification principles which define that “verbosity is permitted,” “strictness is not required,” “default follows the policy,” and “emphasis is not placed on the efficiency” mean that no modification is made to an behavior model generated by behavior model generating means 120.

Words displayed on the input screen for prompting the operator to enter modification principles are not limited to the words shown in FIG. 18. For example, a phrase “duplicated meaningless description” may be displayed instead of the word “verbosity” shown in FIG. 18. Also, a phrase “access to a port not serviced” may be displayed instead of the word “strictness” shown in FIG. 18. Further, a phrase “optimization for increasing the filtering speed” may be displayed instead of the word “efficiency” shown in FIG. 18, and a word “YES” or “NO” may be displayed instead of the phrase “regarded as important” or “not regarded as important”.

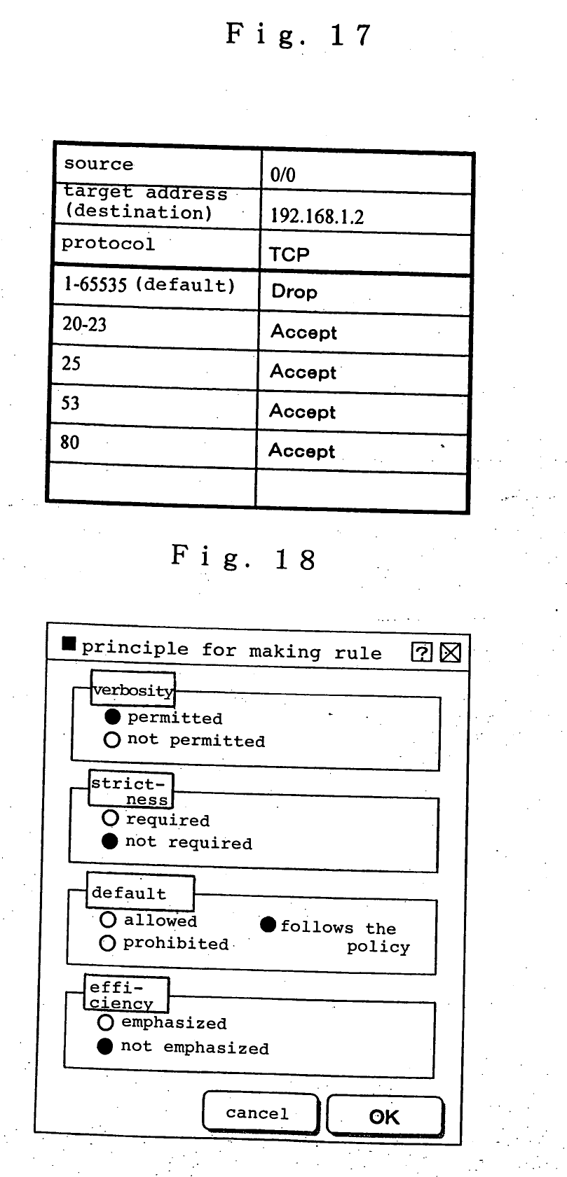

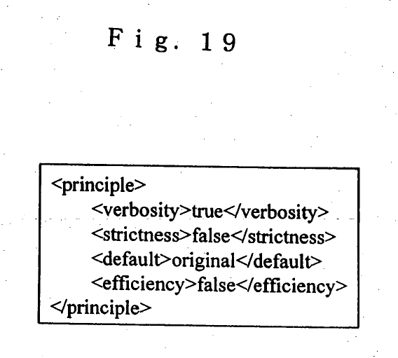

Modifying means 130 receives modification principles through modification principle input means 220. FIG. 18 shows an example in which a screen is displayed for prompting the operator to select a variety of modification principles, forcing the operator to select principles with a mouse or the like. The modification principles may be entered in a manner not limited to the foregoing. For example, modifying means 130 may receive a modification principle described in XML as shown in FIG. 19 through modification principle input means 220. In the example shown in FIG. 19, whether verbosity is permitted or not (true or false) is described in a space sandwiched by verbosity tags. Also, whether strictness is required or not (true of false) is described in a space sandwiched by strictness tags. Further, whether a default is permitted or prohibited or follows the description of the security policy is described in a space sandwiched by default tags. In addition, whether emphasis is placed on the efficiency (true or false) is described in a space sandwiched by efficiency tags.

Modification principle input means 220 may be an input device such as a keyboard, a mouse or the like, through which the operator may enter the modification principles shown in FIG. 19. Alternatively, modification principle input means 220 may be a driver device for reading information from a storage medium, in which case modification principles (for example, those shown in FIG. 19) stored in a file on the storage medium may be read into modifying means 130. Further alternatively, modification principle input means 220 may be a microphone through which audibly generated modification principle may be entered through modifying means 130.

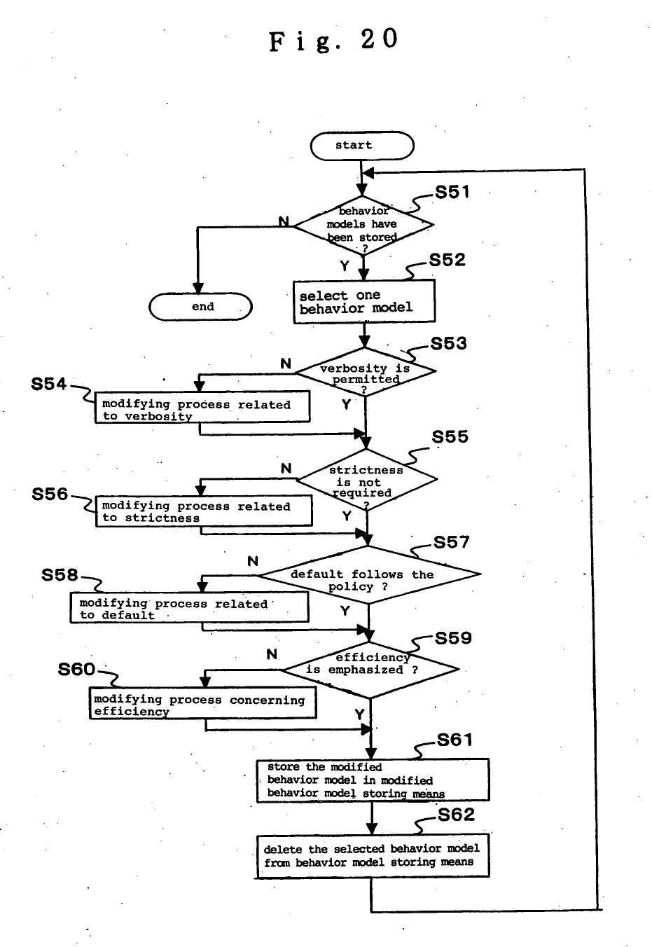

FIG. 20 is a flow chart illustrating a procedure for the behavior model modification made by modifying means 130. Assume that modification principles have already been entered through modification means 130. Modifying means 130 determines whether or not behavior models have been stored in behavior model storing means 103 (step S51). If no behavior models have not been stored in behavior model storing means 103, modifying means 130 terminates the behavior model modification. When behavior models have been stored, modifying means 130 selects one from the behavior models stored in behavior model storing means 103 (step S52).

Subsequently, modifying means 130 determines with reference to the modification principles entered through modification principle input means 220 whether or not a modification principle related to verbosity permits verbosity (step S53). When the modification principle “does not permit verbosity” (N at step S53), modifying means 130 modifies the selected behavior model in accordance with this policy (step S54). Modifying means 130 goes to step S55 after the modification of the behavior model based on the principle which defines that “verbosity is not permitted.” On the other hand, when the modification principle “permits verbosity,” modifying means 130 goes to step S55 next to step S53.

At step S55, modifying means 130 determines, with reference to the modification principles entered through modification principle input means 220, whether or not a modification principle related to strictness requires strictness. When the modification principle defines that strictness is required” (N at step S55), modifying means 130 modifies the selected behavior model in accordance with that principle (step S56). Modifying means 130 goes to step S57 after the modification of the behavior model based on the modification principle which defines that “strictness is required.” On the other hand, in response to the modification principle which defines that “strictness is not required,” modifying means 130 goes to step S57 next to step S55.

At step S57, modifying means 130 determines with reference to the modification principles entered through modification principle input means 220 whether or not a modification principle related to the default permits (Accept) the default, prohibits (Drop) the default, or follows the specification for the default in the security policy. When the modification principle defines that “the default is permitted” or “the default is prohibited” (N at step S57), modifying means 130 modifies the selected behavior model in accordance with the principle (step S58). After the modification at step S58, modifying means 130 goes to step S59. On the other hand, when the modification principle “follows the specification for the default in the security policy,” modifying means 130 goes to step S59 next to step S57.

At step S59, modifying means 130 determines with reference to the modification principles entered through modification principle input means 220, whether or not a modification principle related to efficiency places emphasis on the efficiency. When the modification principle defines that “emphasis is placed on the efficiency” (N at step S59), modifying means 130 modifies the selected behavior model in accordance with the principle (step S60). Modifying means 130 goes to step S61 after the modification of the behavior model based on the modification principle which defines that “emphasis is placed on the efficiency.” Conversely, when the modification principle defines that “emphasis is not placed on the efficiency,” modifying means 130 goes to step S61 next to step S59.

Modifying means 130 does not modify the data structure itself of the behavior model in the modifications at steps S54, S56, S58, S60.

At step S61, modifying means 130 stores the modified behavior model in modified behavior model storing means 140 (step S61). However, when modifying means 130 executes steps S53, S55, S57, S59, S61 in order without going to steps S54, S56, S58, S60, modifying means 130 does not at all modify the behavior model selected at step S52. In this event, modifying means 130 stores the operation mode not modified in modified behavior model storing means 104 as it is. For example, when the modification principles as shown in FIGS. 18 and 19 are entered, modification means 130 goes through steps S53, S55, S57, S59, S61 in this order, and stores the selected behavior model as it is in modified behavior model storing means 104.

Next to step S61, modifying means 130 deletes the behavior model selected at step S52 from behavior model storing means 103 (step S62). After step S62, modifying means 130 repeats the processing at step S51 onward. Upon termination of the behavior model modification, modifying means 130 displays the respective modified behavior models on information output means 300. In this event, the behavior models are displayed in a schematic diagram form as illustrated in FIG. 11.

In the behavior model generation (step S4), an behavior model is generated for each hardware component (network device). In the flow chart illustrated in FIG. 20, each behavior model is selected for modification, and a modified version of each behavior model is stored in modified behavior model storing means 104. Therefore, the modified behavior model also remains for each hardware component (network device).

In this embodiment, the modified behavior models are stored in modified behavior model storing means 104. Rather than such a storing operation, a modified behavior model may be written over the behavior model selected at step S52, and the modified behavior model may be stored in behavior model storing means 103. In the latter scenario, the behavior model may be overwritten at step S61 without the need for the processing at step S62. Also, at step S51, modifying means 130 may determine whether or not behavior model storing means 103 stores an behavior model which is not overwritten by a modified behavior model.

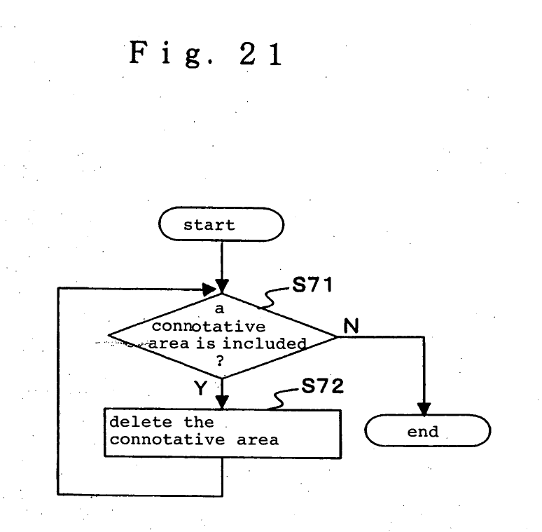

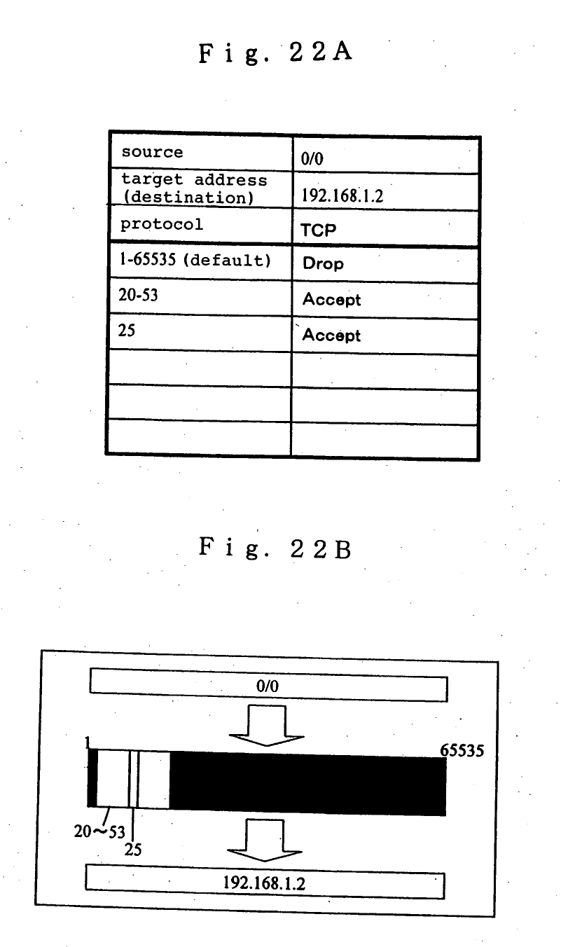

FIG. 21 is a flow chart illustrating a procedure for the modification related to verbosity (step S54). In the modification related to verbosity, modifying means 130 determines whether or not an behavior model selected at step S52 (see FIG. 20) includes a connotative area (step S71). When determining that the behavior model does not include a connotative area (N at step S71), modifying means 130 terminates the modification related to verbosity. The connotative area refers to one of two areas for which the same action is specified (here, ranges of port numbers), which is completely included in the other area. FIGS. 22A, 22B show an exemplary behavior model which includes a connotative area. In the behavior model shown in FIG. 22A, “Accept” is specified for an area “20-53” (a range of port numbers). “Accept” is also specified for an area “25” (a range of port numbers). Therefore, there are two areas for which the same action (“Accept” in this example) is specified, where one area “25” is completely included in the other area “20-53.” In this scenario, the included area “25” falls under a connotative area. The behavior model shown in FIG. 22A can be represented in a schematic diagram form as shown in FIG. 22B. The area of port numbers 20-53 is shown in white for indicating “Accept”. The area of port number 25 (connotative area) is also shown in white for indicating “Accept.”

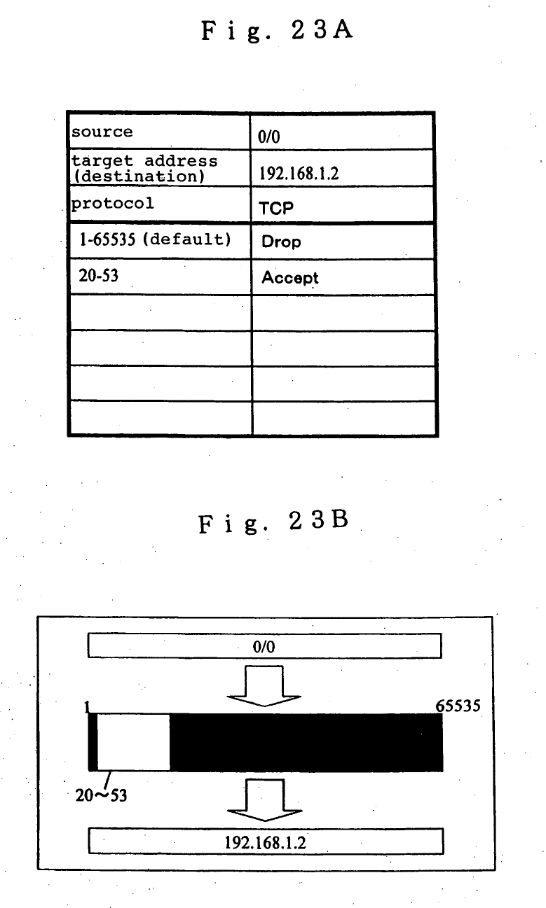

When determining that a connotative area exists in an operation mode (Y at step S71), modifying means 130 deletes the connotative area (step S72). In the example shown in FIG. 22A, since port number “25” for which “Accept” is specified is a connotative area, this connotative area (port number 25 and its action) is deleted. FIGS. 23A, 23B show the behavior model shown in FIG. 22A after the connotative area has been deleted therefrom. As shown in FIG. 23A, port number “25” for which “Accept” is specified is deleted, whereas port numbers “20-53” for which “Accept” is specified are left as it is. The behavior model shown in FIG. 23A can be represented in a schematic diagram form as shown in FIG. 23B. A comparison of FIGS. 22A, 22B with FIGS. 23A, 23B reveals that the verbosity has been eliminated by deleting only the area associated with port number 25 which has been a redundant area.

After step S72, modifying means 130 repeats the processing at step S130 onward. Then, when all connotative areas have been deleted from the behavior model, modifying means 130 determines at step S71 that no connotative area exists (N at step S71), followed by termination of the procedure.

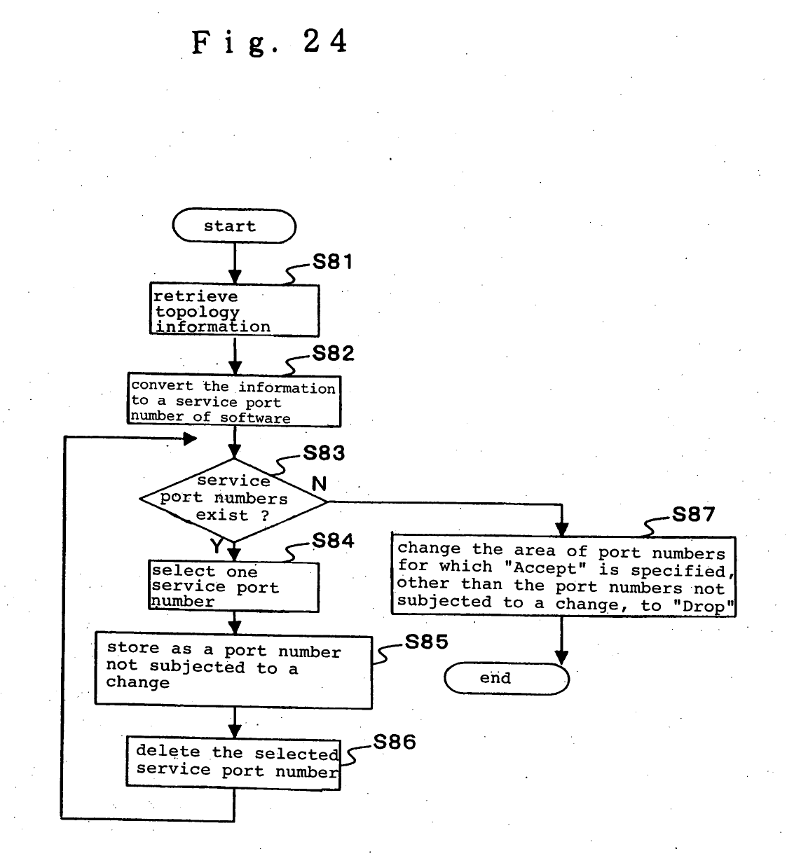

FIG. 24 is a flow chart illustrating a procedure for the modification related to strictness (step S56). In the following, the procedure for the modification related to strictness will be described with reference to FIG. 24. This example will be described on the assumption that the behavior model shown in FIG. 17 is subjected to the modification related to strictness.

In the modification related to strictness, modifying means 130 retrieves topology information from topology storing means 102 (step S81). At step S81, modifying means 130 may retrieve information on software applications installed in a network device identified from an behavior model selected at step S52 from the topology information. For example, assume that an behavior model selected at step S52 is the behavior model shown in FIG. 17. In this behavior model, since “target address (destination)” is “193.168.1.2,” this behavior model is associated with a network device, the network address of which is “193.168.1.2.” Thus, for example, modifying means 130 may retrieve information on software applications installed in a network device, the network address of which is “193.168.1.2,” from the topology information exemplified in FIG. 4. In this example, modifying means 130 may retrieve information (titles) of software applications named “Apache,” “ftp,” and “ssh” from the topology information shown in FIG. 4.

Next, modifying means 130 identifies a service port number associated with each software application based on the information on the software applications retrieved at step S81, and converts the information on each software application to a service port number (step S82). The service port number refers to a port number used by a software application which provides a network service to accept a service request. For example, since Apach is a software application used by a WWW server, Apache is assigned a service port number 80. Ftp is assigned service port numbers 20 and 21. Ssh is assigned a service port number 22. Behavior model generator 100 has previously stored a correspondence relationship between software applications and service port numbers, such that modifying means 130 may reference the correspondence relationship to identify a service port number corresponding to information on a software application retrieved at step S81. In the foregoing example, modifying means 130 may identify service port numbers 80, 20, 21, 22 corresponding to “Apache,” “ftp,” and “ssh,” and convert the information on the respective software applications to these service port numbers 80, 20, 21, 22.

Subsequently, modifying means 130 determines whether or not there are one or more service port numbers converted at step S82 (step S83). Modifying means 130 goes to step S84 when there are one or more service port numbers, and goes to step S87 when there is no service port number. When service port numbers 20, 21, 22, 80 are derived at step S82 in the foregoing example, there are four service port numbers, causing modifying means 130 to go to step S84.

At step S84, modifying means 130 selects one service port number from the one or more service port numbers. For example, when there are service port numbers 20, 21, 22, 80 available, modifying means 130 selects an arbitrary one from these numbers. This example will be described below on the assumption that service port number 20 is selected.

Next, modifying means 130 determines whether or not “Accept” is specified for the service port number selected at step S84 in the behavior model selected at step S52. When “Accept” is specified, this service port number is stored as a port number not subjected to a change (step S85). As will be later described, in the modification related to strictness, part of port numbers for which “Accept” is specified is changed from “Accept” to “Drop.” The port number not subjected to a change refers to a port number, the action of which is not changed to “Drop.” Also, when “Accept” is not specified for a selected service port number, modifying means 130 goes to step S86 without storing this service port number as a port number not subjected to a change.

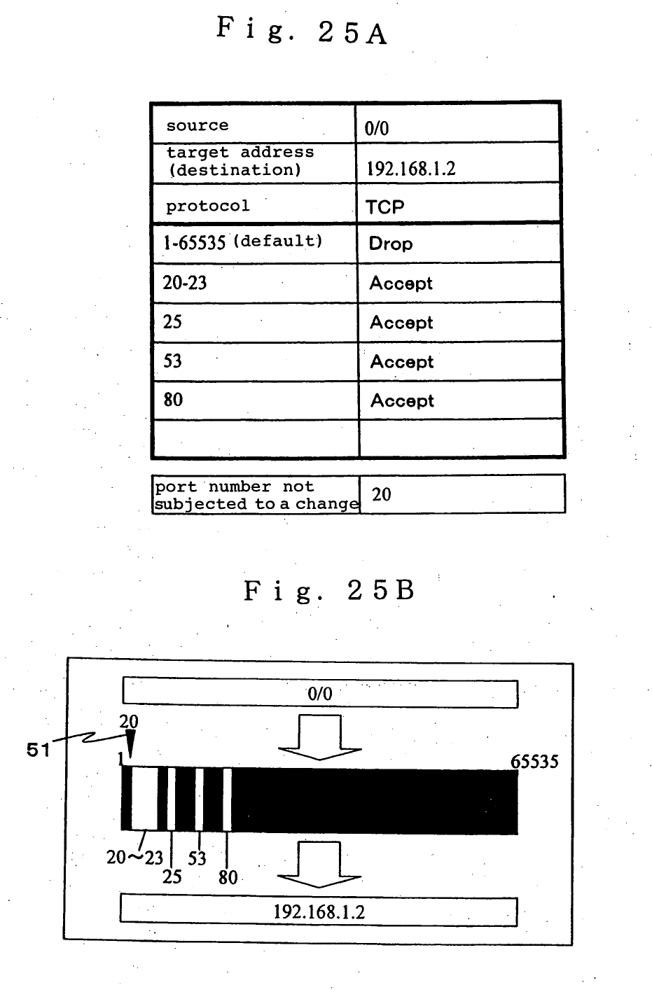

In this example, the behavior model shown in FIG. 17 is subjected to a modification, where “Accept” is specified for port number 20 (see FIG. 17). Therefore, service port number 20 is stored as a port number not subjected to a change. FIG. 25A shows a stored port number not subjected to a change together with the behavior model. Also, the behavior model stored together with the port number not subjected to a change is represented in a schematic diagram form shown in FIG. 25B. In the schematic diagram shown in FIG. 25B, “51” is marked at a location corresponding to the port number not subjected to a change.

As will be later described, modifying means 130 may display the behavior model stored together with the port number not subjected to a change on information output means 300. In this event, “51” is marked at the location corresponding to the port number not subjected to a change in the display as shown in FIG. 25B.

After step S85, modifying means 130 deletes the service port number selected at step S84 (step S86). In this example, since service port number 20 has been selected from four service port numbers 20, 21, 22, 80, modifying means 130 deletes service port number 20. As a result, service port numbers 21, 22, 80 remain.

After step S86, modifying means 130 returns to step S83 to repeat the processing at steps S83-S86. As a result, the remaining service port numbers 21, 22, 80 are selected one by one, and deleted after they have been stored as port numbers not subjected to a change. When modifying means 130 returns to step S83 after all the port numbers have been deleted, there is not any service port number, causing modifying means 130 to go to step S87. FIG. 26A shows examples of the behavior model and port numbers not subjected to a change, which have been stored immediately before modifying means 130 goes to step S87. In the foregoing example, 20, 21, 22, 80 are respectively stored as port numbers not subjected to a change, as shown in FIG. 26A. The behavior model stored together with the port numbers not subjected to a change as shown in FIG. 26A are represented in a schematic diagram form shown in FIG. 26B.

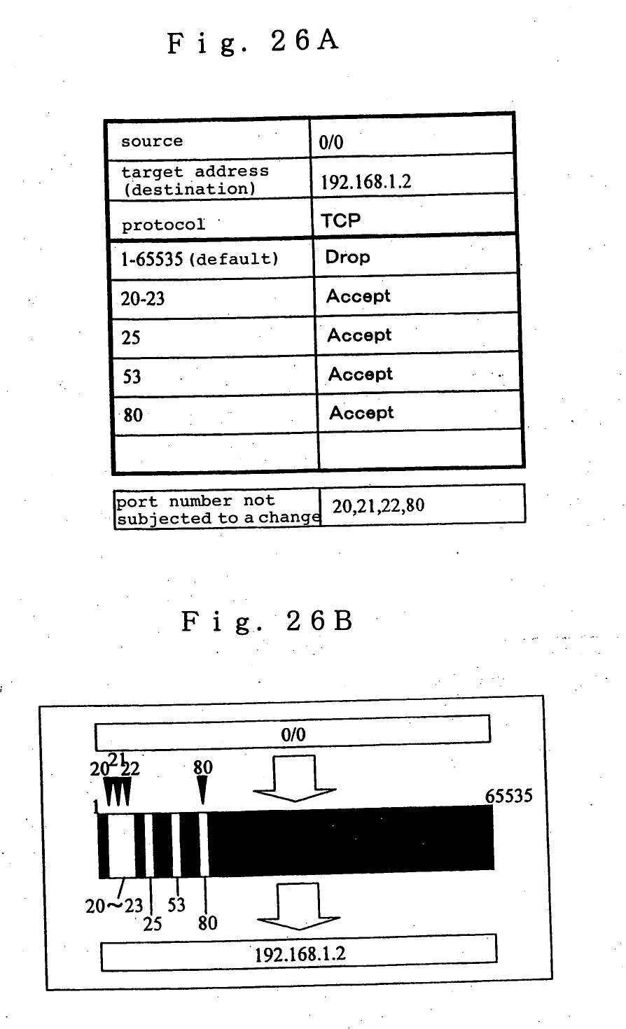

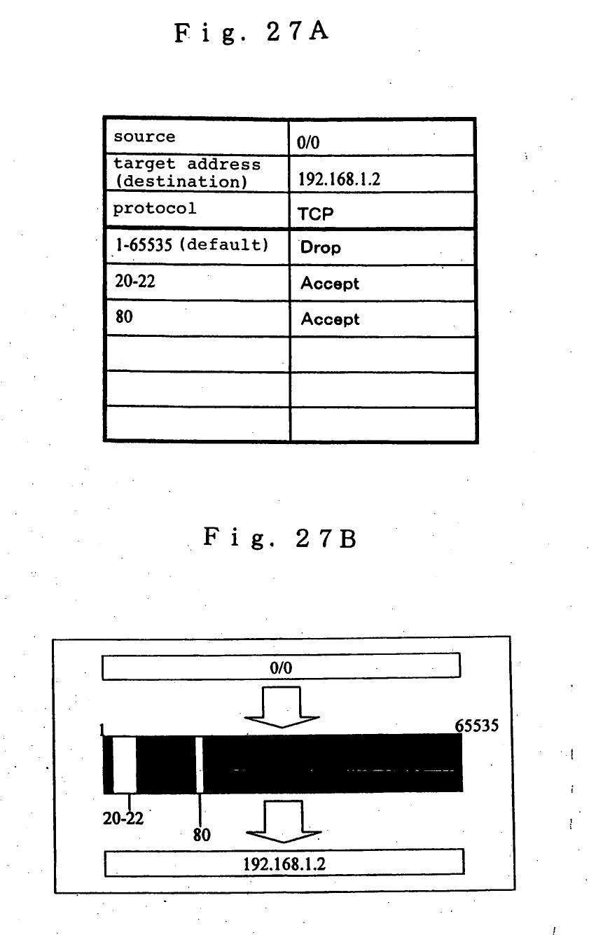

At step S87, modifying means 130 changes the area of port numbers for which “Accept” is specified, other than the port numbers not subjected to a change, to “Drop.” Then, modifying means 130 deletes the stored port numbers not subjected to a change. When modifying means 130 executes the processing at step S87 for the behavior model shown in FIG. 26A, modifying means 130 changes the action of port numbers 23, 25, 53 to “Drop,” other than the port numbers not subjected to a change, within the area of port numbers 20-23, 25, 53, 80 for which “Accept” has been specified. This results in the behavior model changed as shown in FIGS. 27A, 27B. The behavior model shown in FIG. 27A can be represented in a schematic diagram form as shown in FIG. 27B.

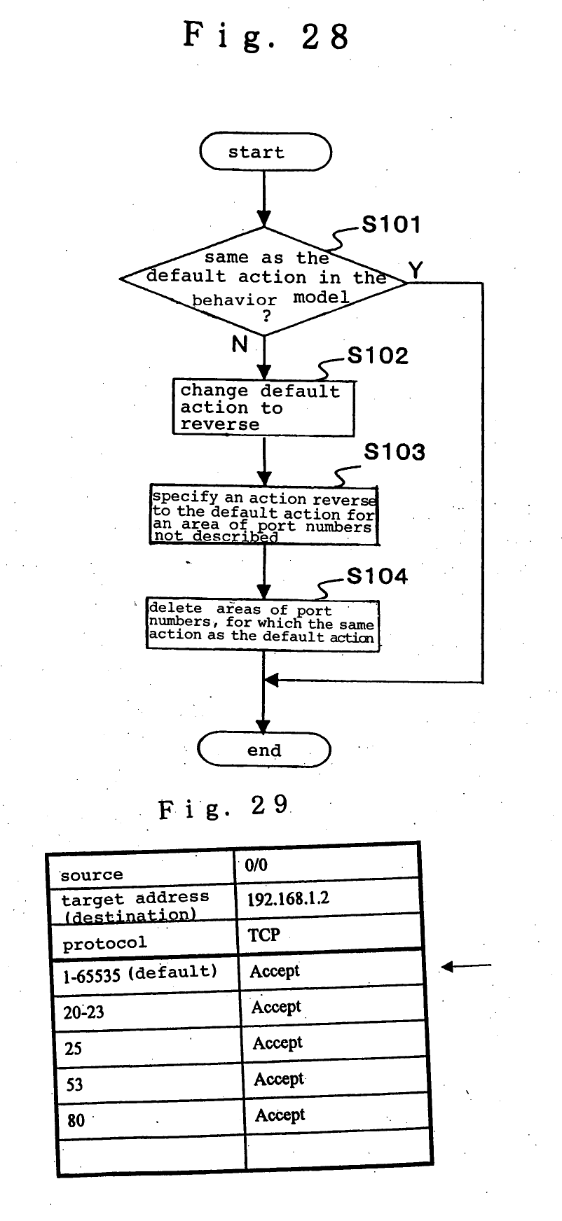

FIG. 28 is a flow chart illustrating a procedure for the modification related to default (step S58). In the following, the procedure for the modification related to default will be described with reference to FIG. 28. This example will be described on the assumption that the behavior model shown in FIG. 17 is subjected to the modification related to default.

The modification related to default at step S58 is executed in response to the entry of a modification principle which defines that “default is permitted” or “default is prohibited.” Modifying means 130 determines whether the default action specified in the modification principle is the same as the default action in the behavior model (step S101). When they are the same (Y at step S101), modifying means 130 terminates the modification related to the default. When they are not the same (N at step S101), modifying means 130 goes to step S102. The default action in the behavior model shown in FIG. 17 is “Drop (prohibition).” Therefore, when an entered modification principle defines that “default is prohibited,” the procedure is terminated. Conversely, when an entered modification principle defines that “default is permitted,” modifying means 130 goes to step S102.

At step S102, modifying means 130 changes the default action in the behavior model to the reverse action (step S102). Specifically, when the default action in the behavior model is “Drop,” this action is changed to “Accept,” and vice versa. In the behavior model shown in FIG. 17, since the default action is “Drop,” this action is changed to “Accept.” After step S102, the behavior model shown in FIG. 17 is changed as shown in FIG. 29. The changed line is indicated by an arrow in FIG. 29.

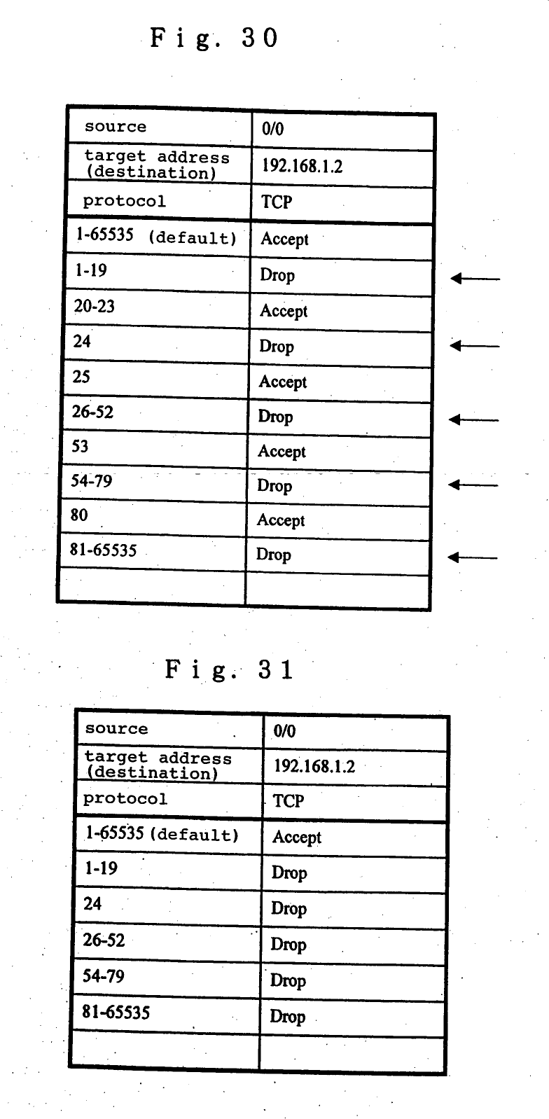

Next, modifying means 130 specifies an action reverse to the default action for an area of port numbers not described in the behavior model (step S103). For example, in the behavior model shown in FIG. 29, no description has been made in areas of port numbers 1-19, port number 24, port numbers 26-52, port numbers 54-79, and port numbers 81-65535. Modifying means 130 adds descriptions of these areas to the behavior model. Modifying means 130 further specifies the action “Drop” reverse to “Accept” which is the default action for these areas. After step S103, the behavior model shown in FIG. 29 is changed as shown in FIG. 30. In FIG. 30, changed lines are indicated by arrows.

Next, modifying means 130 deletes areas of port numbers, for which the same action as the default action of the behavior model is specified, and their action from the behavior model (step S104). For example, in the behavior model shown in FIG. 30, modifying means 130 deletes port numbers 20-23, 25, 53, 80 for which “Accept,” which is the same action as that of the default, is specified, and the action corresponding to the port numbers. After step S104, the behavior model shown in FIG. 30 is changed as shown in FIG. 31. As a result, the behavior model is modified in accordance with the principle which defines that “default is permitted,” such that “Accept” is assigned to the default action.

In the foregoing embodiment, the behavior model shown in FIG. 17 is changed to the behavior model shown in FIG. 31, but when these two models are represented in a schematic diagram form, they are both represented as shown in FIG. 11. In conclusion, the two behavior models represent the same contents of operation even though they differ in data contained therein from each other.

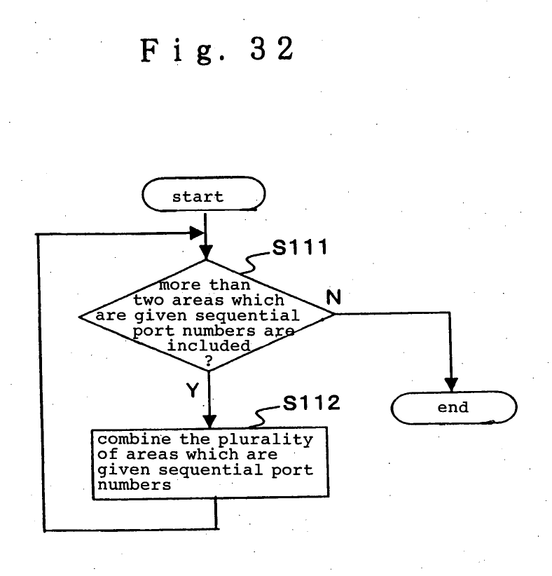

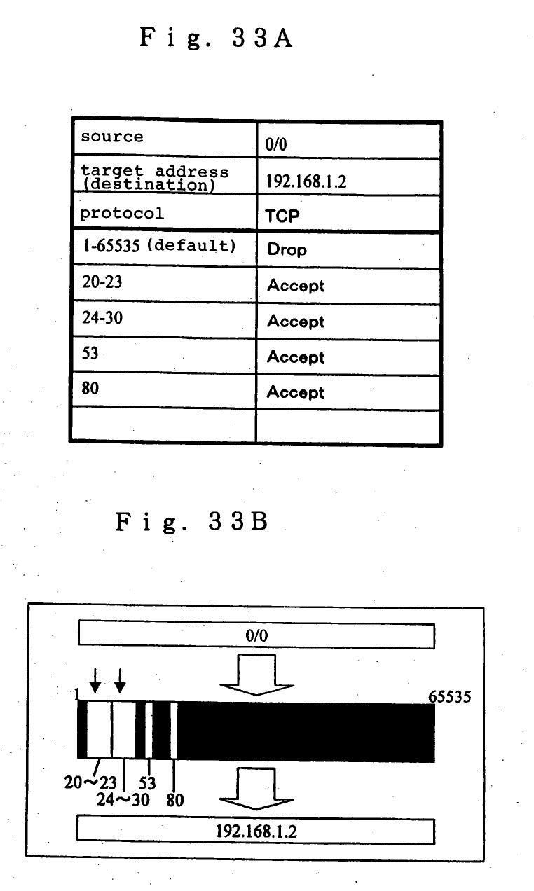

FIG. 32 is a flow chart illustrating a procedure for the modification related to efficiency (step S60). In the following, the procedure for the modification related to efficiency will be described with reference to FIG. 32. The following example will be described on the assumption that an behavior model shown in FIG. 33A is subjected to the modification related to efficiency. The behavior model shown in FIG. 33A can be represented in a schematic diagram form as shown in FIG. 33B.

In the modification related to efficiency, modifying means 130 determines whether or not the behavior model contains areas (ranges of port numbers) which are assigned the same action and given sequential port numbers (step S111). In the example shown in FIG. 33A, the action “Accept” is specified for an area of port numbers 20-23. Also, the action “Accept” is specified for an area of port numbers 24-30. Therefore, the area of port numbers 20-23 is identical in action to the area of port numbers 24-30. Also, port numbers 24-30 are numbers which are continuous to port numbers 20-23. Therefore, these two areas fall under the areas which are assigned the same action and given sequential port numbers.

Also, even with partially overlapping port numbers, if the smallest port number of a certain area to the largest port number of a different area is continuous, the plurality of areas in between fall under the areas across which port numbers are continuous. For example, assume that one area is given port numbers 20-25, while another area is given port numbers 24-30. In this scenario, port numbers 24, 25 overlap in the two areas. In this event, the port numbers are continuous from the smallest port number 20 in one area to the largest port number 30 in the other area. Accordingly, such two areas also fall under the areas which are given sequential port numbers.

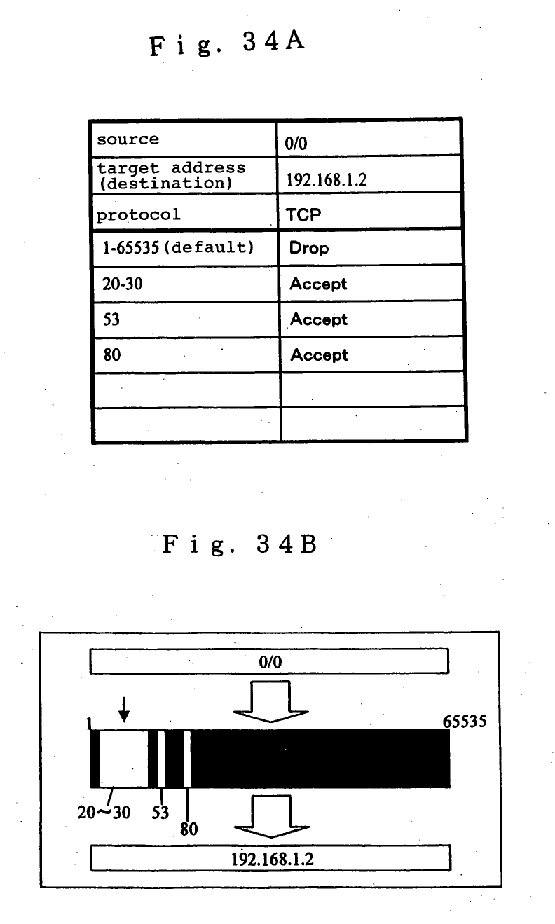

Modifying means 130 terminates the procedure if the behavior model does not contain areas across which port numbers are continuous (N at step S111). On the other hand, when the behavior model contains areas in which the action is the same and port numbers are continuous, modifying means goes to step S112. At step S112, modifying means 130 combines the plurality of areas for which the same action is specified and which are given continuous port numbers, into one area (step S112). In the example shown in FIG. 33A, among a plurality of areas across which port numbers are continuous, port numbers are continuous from the smallest port number 20 in one area to the largest port number 30 in another area, so that these areas can be combined into a single area which has port numbers “20-30.” After step S112, the behavior model shown in FIG. 33A is modified as shown in FIG. 34A. The behavior model shown in FIG. 34A can be represented in a schematic diagram form shown in FIG. 34B. The two separate areas in the behavior model represented in a schematic diagram form in FIG. 33B are combined into a single area in the behavior model represented in a schematic diagram form in FIG. 34B.

Modifying means 130 repeats the processing at step S111 onward after step S112. At step S111, if the behavior model no longer contains areas in which the same action is specified and port numbers are continuous, modifying means 130 terminates the procedure.

While the foregoing example has shown a combination of two areas (the area of “port numbers 20-23” and the area of “port numbers 24-30”) into a single area, three or more continuous areas may be combined into a single area at one time. Assume, for example, that there are an area of port numbers 1-3, an area of port numbers 4-6, and an area of port numbers 7-9. Assume also that the same action is specified for the three areas. In this event, modifying means 130 may combine the three areas into an area having “port numbers 1-9” at one time.

Configuration is generated from the modified behavior model. The network access controller exhibits a different efficiency for a packet filtering operation when configuration generated based on the behavior model shown in FIG. 33A is set in the network access controller (for example, firewall 500 shown in FIG. 5) and when configuration generated based on the behavior model sown in FIG. 34A is set in the network access controller. In this example, the network access controller can be improved in the efficiency of the packet filtering operation by combining areas in which the same action is specified and port numbers are continuous into a single area. In other words, when a packet is transmitted to the network access controller, a determination can be made faster as to whether the packet is permitted to transmit or prohibited from transmitting.

However, the efficiency of the operation of the network access controller can be improved by a modification other than the procedure illustrated in FIG. 32. For example, depending on the type of a particular network access controller, the operation efficiency can be improved more when the network access controller is provided with configuration which is generated from an behavior model that has a less number of areas of port numbers. For example, the behavior model shown in FIG. 17 and the behavior model shown in FIG. 31 represent the same operation. The behavior model shown in FIG. 17 includes four areas, i.e., an area of port numbers 20-23, an area of port number 25, an area of port number 53, and an area of port number 80. The behavior model shown in FIG. 31 in turn includes five areas, i.e., an area of port numbers 1-19, an area of port number 24, an area of port numbers 26-52, an area of port numbers 54-79, and an area of port numbers 81-65535. If the operation efficiency is improved with an behavior model which includes a less number of areas of port numbers, the behavior model illustrated in FIG. 31 may be modified to the behavior model illustrated in FIG. 17 at step S60 to reduce the number of areas.

Here, a determination may be made in the following manner as to whether or not modifying means 130 can reduce the number of areas included in an behavior model. Specifically, modifying means 130 may determine that it can reduce the number of areas included in an behavior model when both the action of an area which includes the smallest port number “1” and the action of an area which includes the largest port number “65535” are different from the default action. Describing in connection with the behavior model shown in FIG. 31 given as an example, the action of the area including the smallest port number “1” is “Drop.” The action of the area including the largest port number “65535” is also “Drop.” The action of the two areas is different from the default action “Accept.” Accordingly, modifying means 130 can determine that the behavior model shown in FIG. 31 can be reduced in the number of areas. Also, for modifying an behavior model to reduce the number of areas included therein, modifying means 130 may execute similar processing as that at steps S102-S104 (see FIG. 28).

In the event of a failure in satisfying the condition defining that both the action of an area including the smallest port number “1” and the action of an area including the largest port number “65535” are different from the default action, the execution of processing similar to that at steps S102-S104 would result in no change or an increase in the number of areas. Also, depending on the algorithm of a packet filtering software application installed in a network access controller, the operation efficiency can be improved in some cases when the access network controller is provided with configuration which is generated from an behavior model in which each port number has a separate area. In such a situation, modifying means 130 may divide an area including a plurality of port numbers into areas each for one of the port numbers at step S60. For example, modifying means 130 may divide an area composed of port numbers 20-23 shown in FIG. 33A into areas for port numbers 20, 21, 22, 23, respectively, and assign an action (“Accept” in this example) to each of the divided areas.

In the description of the flow charts illustrating the procedures for the respective modifications (steps S54, S56, S58, S60), an behavior model given as an example has a default for which “Drop” is specified. For modifying an behavior model in which “Accept” is specified for the default, modifying means 130 may execute processing similar to the aforementioned steps S54, S56, S58, S60.

Also, details on the procedure for the modification related to verbosity (step S54), the procedure for the modification related to strictness (step S56), the procedure for the modification related to default (step S58), and the procedure for the modification related to efficiency (step S60) are not limited to those illustrated in FIGS. 21, 24, 28, and 32, respectively. Each of steps S54, S56, S58, S60 may involve different processing.

In the flow chart illustrated in FIG. 20, modifying means 130 makes the determination on an entered modification principle in the order of steps S53, S55, S57, S59. However, the determination on an entered modification principle is not limited to this order. For example, the determination as to whether a modification principle related to the verbosity permits verbosity or not (step S53) may be made after the determination as to whether a modification principle related to strictness requires the strictness or not (step S55).

In the foregoing embodiment, modifying means 130 is supplied with modification principles from the input screen (GUI) illustrated in FIG. 18, or supplied with modification principles illustrated in FIG. 19. In any manner of entry, modifying means uniformly applies entered modification principles to each behavior model. However, modifying means 130 may not be configured to previously receive modification principles and uniformly apply the modification principles to each behavior model.

In the latter scenario, modifying means 130 prompts the operator to enter a modification principle related to strictness, a modification principle related to verbosity, and a modification principle related to efficiency, separately for each behavior model selected at step S52. The following description will be centered on this operation. In this modification procedure, the processing at steps S51, S52 is similar to that previously described.

Upon selection of one behavior model at step S52, modifying means 130 executes the processing at steps S81-S86 (see FIG. 24). Determining at step S83 that there is no more service port number, modifying means 130 displays on information output means 300 a GUI for prompting the operator to determine whether or not the action of port numbers other than the port numbers not subjected to a change should be changed to “Drop.” FIG. 35 illustrates an example of this GUI. On the GUI, the behavior model is displayed as represented in a schematic diagram form. The GUI also includes radio buttons 71 displayed therein for entering a principle as to whether or not the action of a port number other than the port numbers not subjected to a change should be changed to “Drop.” In the example shown in FIG. 35, among those port numbers for which “Accept” has been specified for their action, radio buttons 71b, 71c are displayed for each of port numbers (25, 53 in the example illustrated in FIG. 35) other than the port numbers not subjected to a change so that the operator can individually specify a port number, the action of which should be changed to “Drop.” The GUI also displays radio button 71 a for specifying that the action of any of the port numbers is not changed to “Drop,” and radio button 71d for changing the action of all port numbers (25 and 53) to “Drop.” A modification principle which defines that “an indicated port is not closed” is synonymous with a modification principle which defines that “strictness is not required.” Also, a modification principle which defines that “an indicated port is closed” is synonymous with a modification principle which defines that “strictness is required.” Modifying means 130 modifies the action of port numbers in accordance with a principle specified by radio buttons 71. However, modifying means 130 applies a modification principle specified by associated radio buttons 71 only to behavior models displayed within the GUI.

Also, the GUI illustrated in FIG. 35 also comprises radio buttons 72 for entering a modification principle which is uniformly applied to behavior models which are selected the next time onward. Radio buttons 72 can specify a modification principle which defines that “subsequently, an indicated port is not closed” or “subsequently, an indicated port is closed.” The modification principle which defines that “subsequently, an indicated port is not closed” is synonymous with a modification principle which defines that “strictness is not required.” When this modification principle is specified by associated radio button 72, modifying means 130 uniformly applies the modification principle which defines that “strictness is not required” to behavior models which are selected the next time onward. On the other hand, the modification principle which defines that “subsequently, an indicated port is closed” is synonymous with a modification principle which defines that “strictness is required.” When this modification principle is specified by associated radio button 72, modifying means uniformly applies the modification principle defining that “strictness is required” to behavior models which will be selected the next time onward.

In the example illustrated in FIG. 35, the operator has specified radio button 71a. Accordingly, modifying means 130 keeps indicted ports (Nos. 25 and 53) unchanged for a displayed behavior model, so that “Accept” is still specified for their action. In addition, in the example illustrated in FIG. 35, the modification principle which defines that “subsequently, an indicated port is not closed” is also specified. Accordingly, modifying means 130 does not perform an operation for changing the action of port numbers to “Drop,” other than the port numbers not subjected to a change, for behavior models which may be selected at step S52 in the next loop onward.

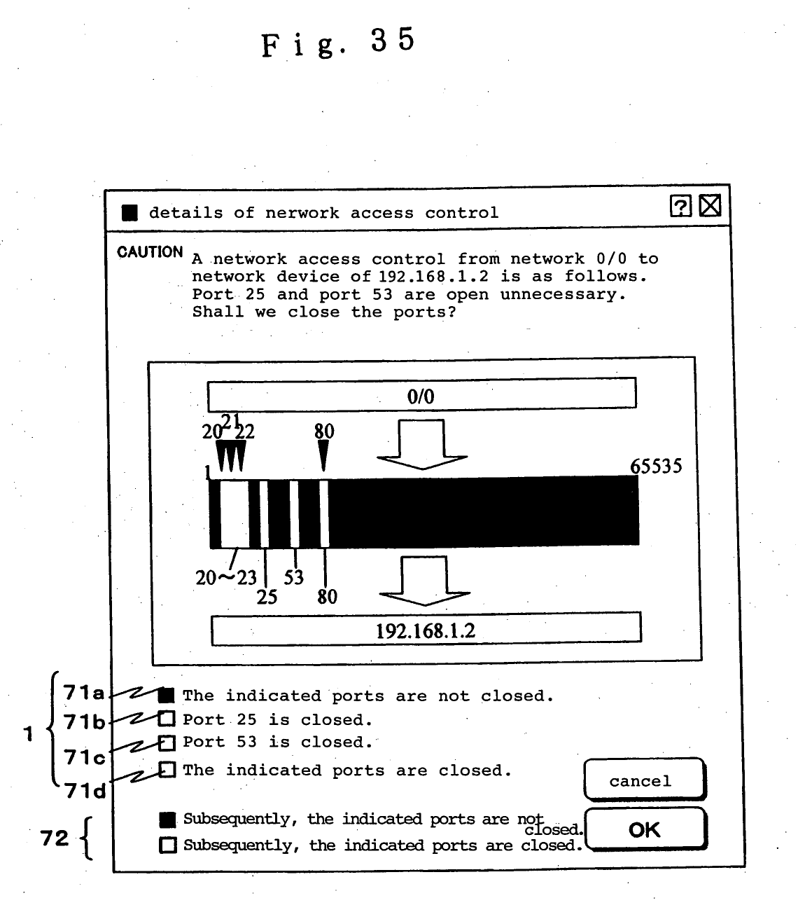

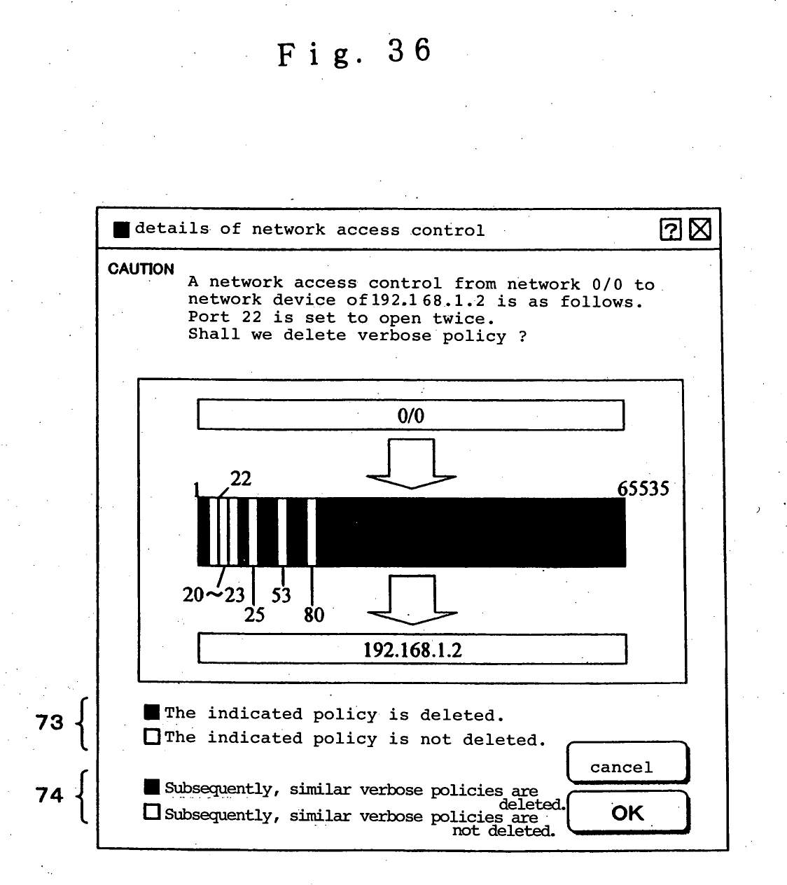

After modifying the behavior model selected at step S52 in accordance with the principle entered from the GUI illustrated in FIG. 35, modifying means determines whether or not the behavior model includes a connotative area (in a manner similar to step S71 shown in FIG. 21). In this event, if a connotative area is found, modifying means 130 displays on information output means 300 a GUI for prompting the operator to determine whether the connotative area should be deleted or not. FIG. 36 illustrates an example of this GUI. The GUI illustrated in FIG. 36 displays a selected behavior model (in a schematic diagram form). Modifying means 130 also displays radio buttons 73 for entering a principle as to whether a connotative area should be deleted or not. In the example illustrated in FIG. 36, radio buttons 73 are displayed to specify either a principle which defines that “an indicated policy is deleted” or “an indicated policy is not deleted.” The “indicated policy” in the example illustrated in FIG. 36 specifically refers to a rule which defines that “transmission is permitted for a packet which has the destination address “193.168.1.2” and the destination port number 22.” The modification principle which defines that “an indicated policy is not deleted” shown in FIG. 36 is synonymous with a modification principle which defines that “verbosity is permitted.” However, modifying means 130 applies a modification specified by associated radio button 72 shown in FIG. 36 only to an behavior model displayed within the GUI.

The GUI illustrated in FIG. 36 also comprises radio buttons 74 for entering a modification principle which is uniformly applied to behavior models which will be selected the next time onward. Radio buttons 74 permit the operator to specify a modification principle which defines that “subsequently, similar verbose policies are deleted” or “subsequently, similar verbose policies are not deleted.” The modification principle which defines that “subsequently, similar verbose policies are deleted” is synonymous with the modification principle which defines that “verbosity is not permitted.” When this modification principle is specified by associated radio button 74, modifying means 130 uniformly applies the modification principle defining that “verbosity is not permitted” to behavior models which will be selected the next time onward. On the other hand, the modification principle which defines that “subsequently, similar verbose policies are not deleted” is synonymous with the modification principle which defines that “verbosity is permitted.” When this modification principle is specified by associated radio button 74, modifying means 130 uniformly applies the modification principle defining that “verbosity is permitted” to behavior models which will be selected the next time onward.

In the example illustrated in FIG. 36, the operator has specified the modification principle which defines that “an indicated policy is deleted.” Accordingly, modifying means 130 deletes the area of port number 22, which constitutes a connotative area, and the action of port number 22 for the displayed behavior model. Also, in the example illustrated in FIG. 36, the operator has also specified the modification principle which defines that “subsequently, similar verbose policies are deleted.” Accordingly, modifying means 130 modifies behavior models selected at step S52 the next time onward to delete a connotative area.

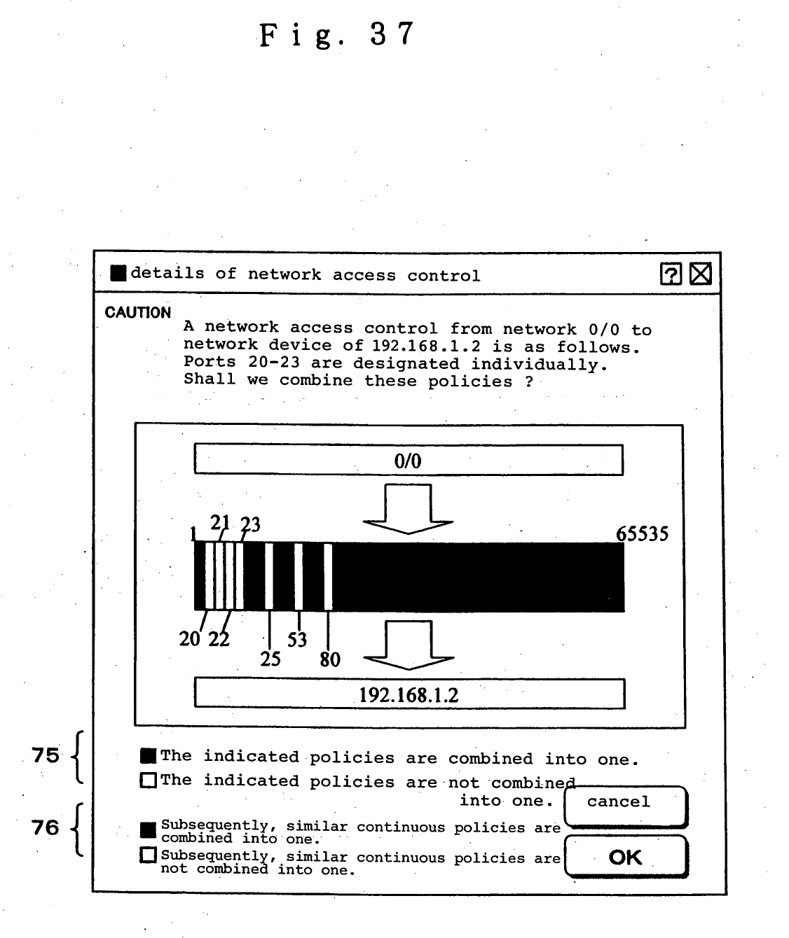

After modifying the behavior model selected at step S52 in accordance with the principles entered from the GUI illustrated in FIG. 36, modifying means 130 determines whether or not the modified behavior model includes two or more continuous areas (in a manner similar to step S111). In this event, if the modified behavior model includes two or more continuous areas, modifying means 130 displays on information output means 300 a GUI for prompting the operator to determine whether or not two or more continuous areas should be combined into a single area. FIG. 37 illustrates an example of this GUI. The GUI illustrated in FIG. 37 displays a selected behavior model (in a schematic diagram form). Modifying means 130 also displays radio buttons 75 within the GUI for entering a principle as to whether or not two or more continuous areas should be combined into a single area. In the example illustrated in FIG. 37, radio buttons 75 are displayed such that the operator can specify either a principle which defines that “indicated policies are combined into one” or “indicated policies are not combined into one.” In the example illustrated in FIG. 37, “indicated policies” refers to rules which include descriptions of respective destination ports 20, 21, 22, 23. The modification principle which defines that “indicated policies are combined into one” shown in FIG. 37 is synonymous with the modification principle which defines that “emphasis is placed on the efficiency.” On the other hand, the modification principle which defines that “indicated policies are not combined into one” shown in FIG. 37 is synonymous with the modification principle which defines that “emphasis is not placed on efficiency.” However, modifying means 130 applies a modification specified by associated radio button 72 shown in FIG. 37 only to the behavior model displayed in the GUI.

The GUI illustrated in FIG. 37 also comprises radio buttons 76 for entering a modification principle which is uniformly applied to behavior models which will be selected the next time onward. Radio buttons 76 permit the operator to specify a modification principle which defines that “subsequently, similar continuous policies are combined into one” or “subsequently, similar continuous policies are not combined into one.” The modification principle which defines that “subsequently, similar continuous policies are combined into one” is synonymous with the modification principle which defines that “emphasis is placed on efficiency.” When this modification principle is specified by associated radio button 76, modifying means 130 uniformly applies the modification principle defining that “emphasis is placed on the efficiency” to behavior models which will be selected the next time onward. On the other hand, the modification principle which defines that “subsequently, similar continuous policies are not combined into one” is synonymous with the modification principle which defines that “emphasis is not placed on the efficiency.” When this modification principle is specified by associated radio button 76, modifying means 130 uniformly applies the modification principle defining that “emphasis is placed on the efficiency” to behavior models which will be selected the next time onward.

In the example illustrated in FIG. 37, the operator has selected the modification principle which defines that “indicated policies are combined into one.” Accordingly, modifying means 130 modifies a displayed behavior model to combine the respective areas of port numbers 20, 21, 22, 23 into a single area. In the example illustrated in FIG. 37, the operator has also specified the modification principle which defines that “subsequently, similar continuous policies are combined into one.” Accordingly, modifying means 130 modifies behavior models selected at step S52 the next time onward to combine a plurality of continuous areas into a single area.

In the foregoing description, the GUIs illustrated in FIGS. 35, 36, 37 are displayed in sequence for a single behavior model. However, for convenience of description, different behavior models are used in the description in FIGS. 35, 36, 37. For example, although the GUI of FIG. 36 should display a modified behavior model related to strictness, as specified on the GUI of FIG. 35, another behavior model is shown in FIG. 36 for convenience of description.

The modification principle related to the default action is preferably determined such that it is collectively applied to all behavior models, rather than specified for one behavior model to another. Specifically, the modification principle related to the default action is preferably specified in the manner as described in connection with FIGS. 18 and 19, rather than specified on the GUIs as illustrated in FIGS. 35 to 37.

Next described is the generation of configuration (step S6) by configuration generating means 140. Configuration generating means retrieves an behavior model modified by modifying means 130 from modified behavior model storing means 104. Modified behavior model storing means 104 stores zero or more behavior model. Configuration generating means 140 selects one from the retrieved behavior models.

Network access controllers tend to have software applications installed therein for controlling network accesses. Such software applications include, for example, “Firewall-1,” “Netscreen” and the like. Network access controllers may also have packet filtering software applications installed therein, including “ipchains,” “iptables” and the like. Network access controllers may further have network service super-server software applications installed therein, including “inetd,” “xinetd” and the like. “Firewall-1,” “Netscreen,” “ipchains,” “iptables,” “inetd,” and “xinetd” individually listed above are the names of software applications. Configuration generating means 140 generates configuration specific to a variety of network access controllers (or software applications installed in the controllers) from modified behavior models. As previously described, the configuration defines the operation of a particular network access controller.

Configuration generating means 140 invokes a conversion rule for generating configuration described in a format specific to a particular network access controller from conversion rule storing means 150 for generating the configuration. The conversion rule is defined for converting a modified behavior model to configuration specific to a network access controller.

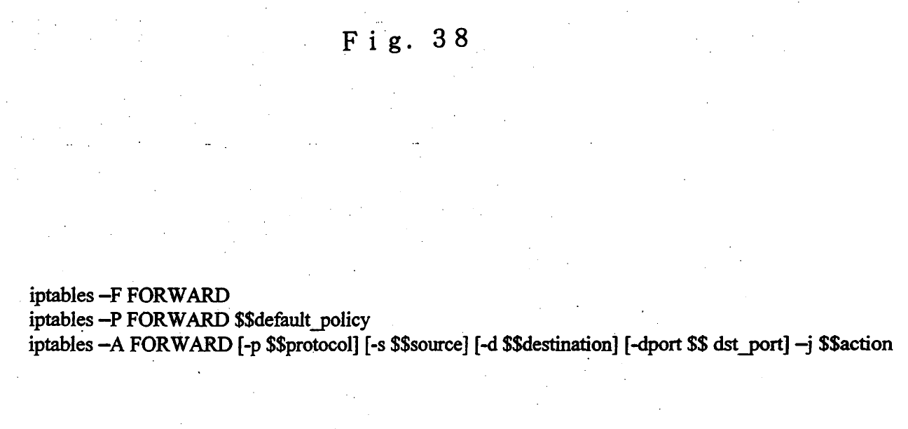

FIG. 38 shows an example of the conversion rule. This example shows a conversion rule for generating configuration for a network access controller which executes processing in accordance with “iptables.” The first line of the conversion rule shown in FIG. 38 is described without fail when “iptables” is used. The second line describes a default action (“Accept” or “Drop”). Third and subsequent lines describe an action related to each area of an individual port number. When actions described on the third line onward are not applied, the default action described on the second line is applied.

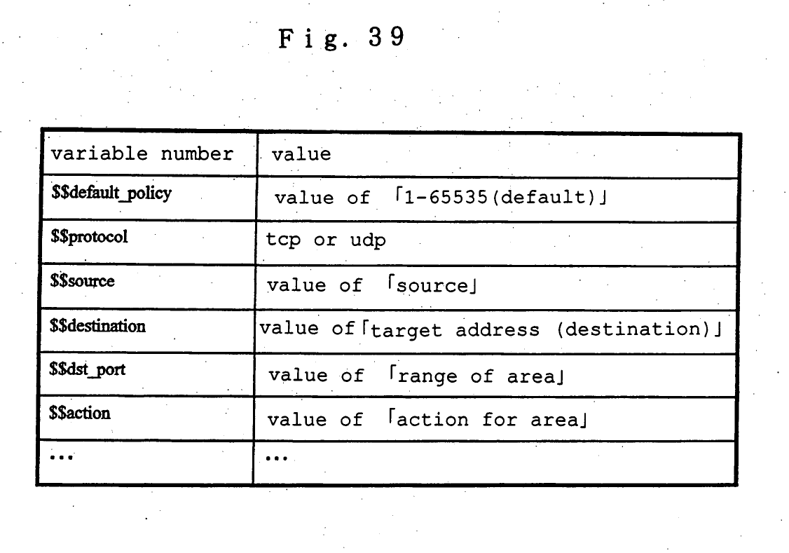

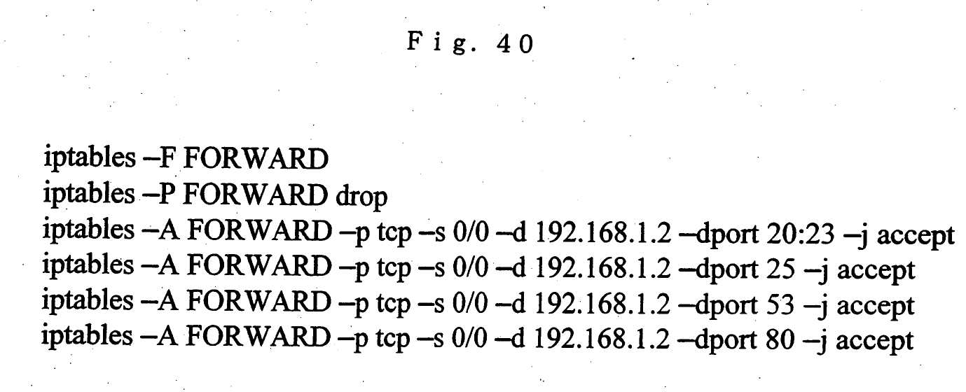

As shown in FIG. 38, an item described together with a symbol “$$” has indefinite contents. Configuration generating means 140 extracts data included in an behavior model, and replaces an indefinite item in the conversion rule with the data to convert the behavior model to configuration. As a result, configuration generating means 140 generates the configuration. FIG. 39 shows an exemplary correspondence relationship between indefinite portions determined in the conversion rule and data included in the behavior model. Specifically, the table shows which part of the conversion rule should be replaced with which data in the behavior model. As shown in FIG. 39, configuration generating means 140 may replace “$$default_policy” with the value of “1-65535” which indicates the default action in the behavior model. Likewise, configuration generating means 140 may replace “$$protocol” with the value of “protocol” (tcp or udp) in the behavior model. Further, configuration generating means 140 may replace “$$source” with the value of “source” in the behavior model. Configuration generating means 140 may replace “$$destination” with the value of “target address (destination) in the behavior model. Configuration generating means 140 may replace “$$dst_port” with “range of area” or the range of individual port numbers (for example, a range of 20 to 23 and the like). Configuration generating means 140 may replace “$$action” with “action for area” or an action corresponding to a range of individual port numbers. For example, when the behavior model shown in FIG. 17 is converted to configuration in accordance with the conversion rule shown in FIG. 38, configuration shown in FIG. 40 is generated.

In this way, configuration generating means 140 generates configuration by replacing indefinite items in the conversion rule with appropriate data included in the behavior model.

FIG. 40 shows the configuration generated from the single behavior model shown in FIG. 17. Configuration may be generated from a plurality of behavior models. In this event, if a common default action is described in the plurality of behavior models, the descriptions corresponding to the first and second lines in the conversion rule shown in FIG. 38 may be shared by the plurality of behavior models. In other words, even if there are a plurality of behavior models, resultant configuration may include one line of description corresponding to each of the first and second lines of the conversion rule shown in FIG. 38.

In the foregoing description, the configuration is generated by replacing indefinite items in the conversion rule with associated data included in the behavior model, but configuration generating means 140 may generate the configuration through other processing.

Configuration converting means 140 generates the configuration using a modified behavior model. Therefore, the modification principle of the behavior model is also reflected to the configuration. For example, a variety of principles such as “verbosity is permitted,” “strictness is required,” “default is prohibited,” “emphasis is placed on the efficiency” and the like are reflected to the configuration as well.

Configuration generating means 140 displays the generated configuration on information display means 300. While information output means 300 is a display device in the example described herein, information output means 300 may comprise a printer for printing out the configuration. Alternatively, information output means 300 may comprise a storage medium driver device for writing information into a storage medium, in which case the configuration may be written into a storage medium. Further alternatively, information output means 300 may comprise a network interface through which the configuration may be transmitted to another computer. Also, information output means 300 may comprise an audio output device such as a speaker, in which case the configuration may be audibly output.

Next described are effects produced by the foregoing embodiment. In the present invention, an behavior model is generated from a security policy described in a natural language or the like such that the behavior model is represented by a data structure independent of descriptions which depend on the type of network access controller. Since the behavior model is not described in a format specific to each network access controller, the present invention can solve the problem of “difficulties in confirming the intention of a security policy creator.” Particularly, the intention of the security policy creator can be more clearly presented by displaying the behavior model represented in a schematic diagram form. Further, even if the design guidelines for a security policy differ from one creator to another, the present invention can prevent maintenance operations from being difficult by solving the problem of “difficulties in confirming the intention of a security policy creator.” In other words, the present invention can also solve the problem of “difficulties in maintaining the consistency.”

Also, even if a security policy described in a natural language or the like includes missing items or omitted items, policy normalizing means 110 compensates the security policy for such missing items and omitted items. Therefore, even if an entered security policy includes missing items or omitted items, an behavior model can be generated from this security policy.

Since modifying means 130 modifies an behavior model in accordance with a desired modification principle of an operator, the present invention can derive configuration desired by the operator. For example, an behavior model can be modified in accordance with a modification principle which defines that “emphasis is placed on efficiency.” As a result, when a network access controller is operated in accordance with configuration generated from the modified behavior model, it is possible to determine at higher speeds whether a transmitted packet is permitted to transmit or prohibited from transmitting. Also, for example, a default action of an behavior model can be changed to an action desired by the operator, and as a result, the default action in the configuration can also be changed to the action desired by the operator. In other words, the configuration can be generated in a description format which can be defined in a flexible manner.

Also, by modifying an behavior model in accordance with a principle which defines that “verbosity is permitted” or “verbosity is not permitted,” it is possible to generate configuration in accordance with the principle which defines that “verbosity is permitted” or “verbosity is not permitted.” Similarly, by modifying an behavior model in accordance with a principle which defines that “strictness is required” or “strictness is not required,” it is possible to generate configuration in accordance with the principle which defines that “strictness is required” or “strictness is not required.”

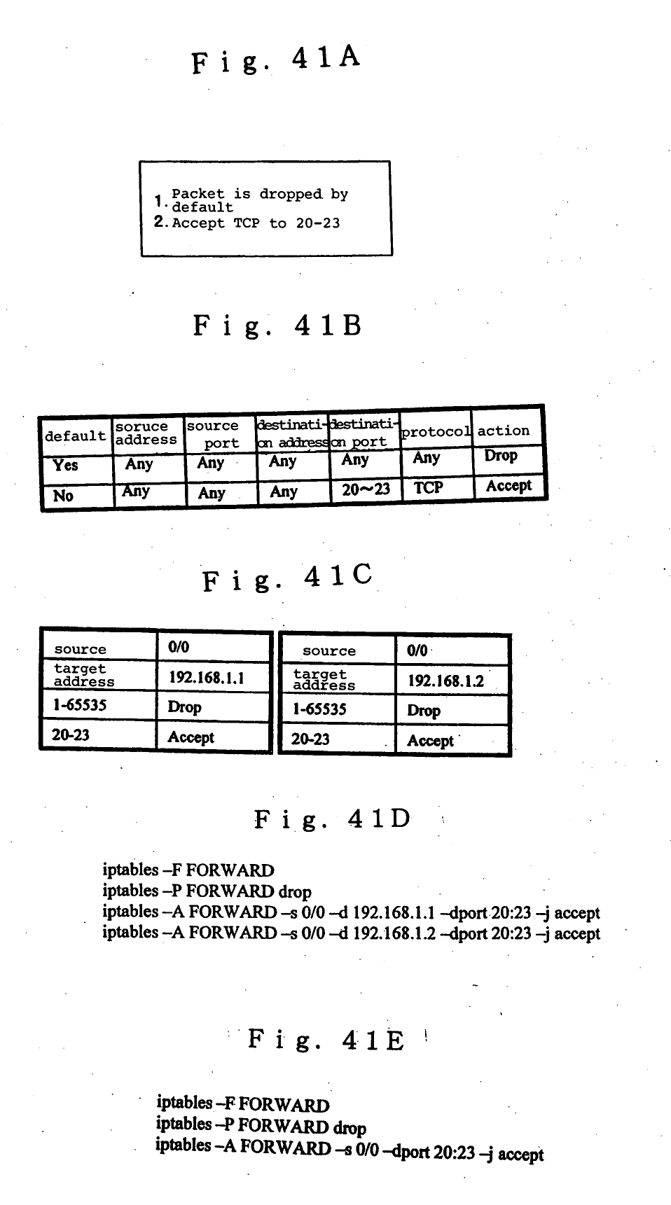

In the foregoing embodiment, the generated configuration may be reconfigured to make the configuration more compact. Making the configuration more compact means, for example, a reduction in the number of lines in the configuration. FIGS. 41A to 41E show an exemplary progress of processing from the entry of a security policy to the reconfiguration of configuration. Assume that a security policy described in a natural language, as illustrated in FIG. 41A, is entered through the behavior model generator. FIG. 41B shows a normalized version of the security policy resulting from the normalization performed by policy normalizing means 110. Assume that topology information describes only a hardware component which is assigned a network address “193.168.1.1” and a hardware component which is assigned a network address “193.168.1.1.” FIG. 41C shows exemplary behavior models for the respective hardware components, generated by behavior model generating means 120. Assume that no modification has been made to the behavior models. FIG. 41D shows exemplary configuration generated by configuration generating means 140 based on the behavior models shown in FIG. 41C. In this example, the default action in both the two behavior models shown in FIG. 41C is “Drop,” so that descriptions corresponding to the first and second lines in the conversion rule shown in FIG. 38 are commonly used in the configuration shown in FIG. 41D. Specifically, although two behavior models have been generated, there is only one description for each of the descriptions corresponding to the first line and second line in the conversion rule shown in FIG. 38. In FIG. 41E, the descriptions on the third and fourth lines are collected into one line by omitting the description of a destination address on the third and fourth lines in FIG. 41D.

The descriptions on the third and fourth lines in FIG. 41D differ only in the destination address, and are common in the remaining items. Also, in regard to hardware, the topology information only describes the hardware component which is assigned “193.168.1.1” and the hardware component which is assigned “193.168.1.1.” Therefore, even if a plurality of lines are collected into a single line by omitting the description of the destination address as shown in FIG. 41E, it is possible to control accesses to the hardware components included in the topology information of this example without hindrance. In this way, the configuration may be reconfigured to reduce the number of lines included therein.

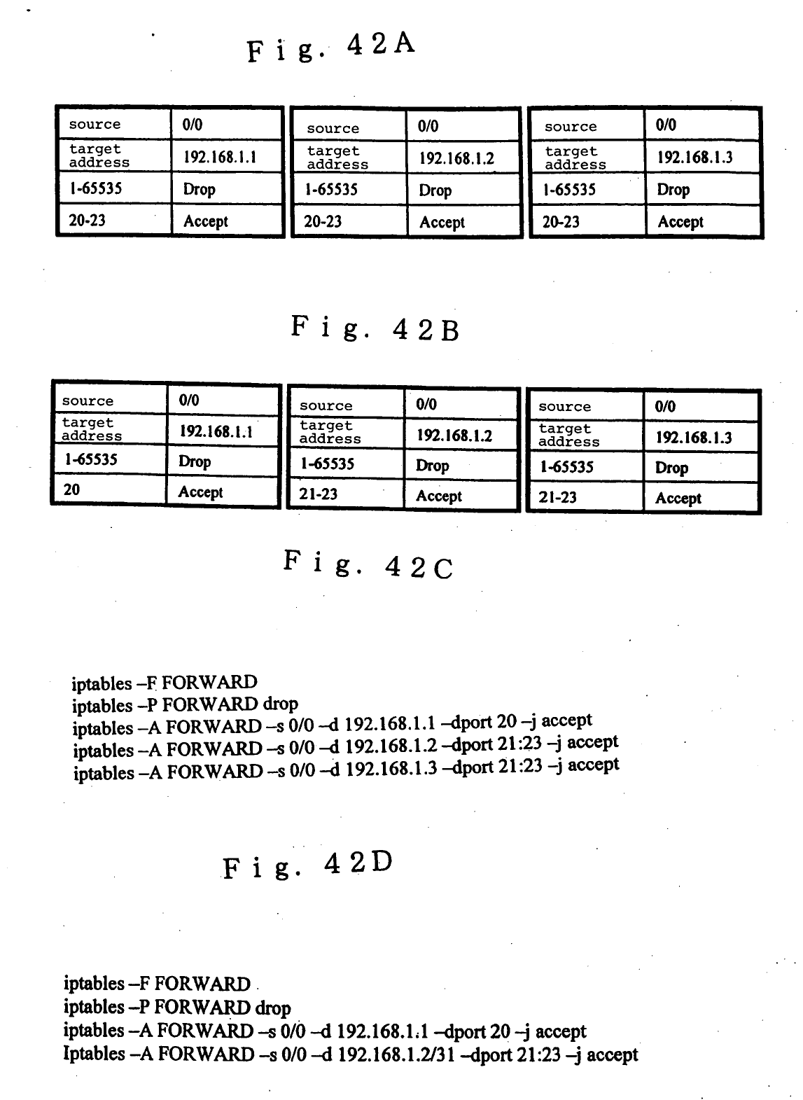

In the example described in connection with FIGS. 41A to 41E, the behavior models are not modified. Next, an example of reconfiguring configuration will be shown, when behavior models are modified, with reference to FIGS. 42A to 42D. FIG. 42A shows exemplary behavior models generated by behavior model generating means 120. Assume in this example that three behavior models have been generated. In the respective behavior models, the areas of destination ports are commonly set to “20-23.” FIG. 42B shows exemplary behavior models modified by modifying means 130. Assume that port numbers of the respective behavior models are modified to “20,” “21-23,” and “21-23,” respectively. In other words, after the modification, the same port numbers are assigned to the area of port number in two of the three behavior models. FIG. 42C shows exemplary configuration created from the modified behavior models. In this example, the default actions in the three behavior models shown in FIG. 42B are all “Drop,” so that the descriptions corresponding to the first and second lines in the conversion rule shown in FIG. 38 are commonly used in the configuration shown in FIG. 42C. Specifically, although three behavior models have been generated, there is only one description for each of the descriptions corresponding to the first line and second line in the conversion rule shown in FIG. 38.

FIG. 42D shows an example of a reconfigured version of the configuration shown in FIG. 42C. The description on the third line shown in FIG. 42C relates to destination port number “20” which is different from the descriptions on the fourth and fifth lines. Thus, the third line shown in FIG. 42C is described in a similar manner even after the reconfiguration. On the fourth and fifth lines shown in FIG. 42C, the description of destination port numbers is common. Also, destination address “193.168.1.2” described on the fourth line in FIG. 42C, and destination address “193.168.1.3” described on the fifth line in FIG. 42C can be represented using a net mask. The fourth and fifth lines shown in FIG. 42C differ only in the destination address, but the two destination address can be collected using the net mask, so that the two lines can be collected into a single line as the fourth line shown in FIG. 42D.

The examples shown in FIGS. 41A to 41E and 42A to 42D demonstrate the reconfiguration of configuration after the generation of the configuration. Alternatively, prior to the generation of configuration, behavior models may be modified to reduce the number of lines in configuration, and the configuration may be generated from the modified behavior models.

In addition, the operator may be prompted to determine whether configuration should be reconfigured or not, such that the configuration is reconfigured in response to an entered instruction which requires the reconfiguration (alternatively, behavior models may be modified to reduce the number of lines in configuration, and the configuration may be created from the modified behavior models).

The present invention can be applied, for example, to the generation of an behavior model which represents the operation of a firewall, a router, and a network access controller which has a packet filtering software application installed therein. The present invention can also be applied to a device which generates configuration for defining the operation of a network access controller based on an behavior model.

While preferred embodiments of the present invention have been described Using specific terms, such description is for illustrative purposes only, and it is to be understood that changes and variations may be made without departing from the spirit or scope of the following claims.

What is claimed is:

1. An behavior model generator system comprising:
policy storing means for storing a security policy including at least a transmission permission condition or a transmission prohibition condition for communicated data;
topology storing means for storing topology information which describes information on a device connected to a communication network to which a network access controller is connected, said network access controller performing at least an operation for permitting the communicated data to transmit or an operation for prohibiting the communicate data from transmitting; and
behavior model generating means for generating an behavior model based on the security policy stored in said policy storing means, said behavior model including data representative of the operation of said network access controller for each device described in the topology information.

2. The behavior model generator system according to claim 1, further comprising policy input means for entering a security policy,
wherein said policy storing means stores a security policy entered through said policy input means.

3. The behavior model generator system according to claim 1, further comprising topology information input means for entering topology information,
wherein said topology storing means stores topology information entered through said topology information input means.

4. The behavior model generator system according to claim 1, further comprising policy normalizing means, operable when the security policy does not include a description related to a predefined item, for executing normalization for adding a description related to the item to the security policy,
wherein said behavior model generating means generates an behavior model based on the normalized security policy.

5. The behavior model generator system according to claim 1, further comprising:
conversion rule storing means for storing a conversion rule for use in converting the behavior model to configuration for defining the operation of said network access controller, said configuration being described in a format dependent on the type of said network access controller; and
configuration generating means for converting the behavior model to the configuration in accordance with the conversion rule.

6. The behavior model generator system according to claim 1, further comprising:
modification principle input means for entering a modification principle for an behavior model generated by said behavior model generating means; and
modifying means for modifying the behavior model in accordance with the modification principle.

7. The behavior model generator system according to claim 6, further comprising information output means for displaying an image, wherein:
said modifying means displays a user interface on said information output means for displaying a plurality of candidate modification principles to prompt a user to select a modification principle.

8. The behavior model generator system according to claim 6, wherein:
said modifying means is responsive to a modification principle entered through said modification principle input means, said modification principle defining that verbosity of the behavior model is not permitted, for modifying an behavior model to delete duplicate information in information included in the behavior model.

9. The behavior model generator system according to claim 8, further comprising information output means for displaying an image, wherein:
said modifying means displays a user interface on said information output means for showing a modification principle which defines that verbosity is not permitted for an behavior model and a modification principle which defines that verbosity is permitted for an behavior model to prompt the user to select one of the modification principles.

10. The behavior model generator system according to claim 6, wherein:
said topology storing means stores topology information including information on a software application installed in each device; and
said modifying means is responsive to a modification principle entered through said modification principle input means, said modification principle defining that strictness is required for the behavior model, for modifying an behavior model to delete information other than information related to the software application installed in a device corresponding to the behavior model from information included in the behavior model based on the topology information.

11. The behavior model generator system according to claim 10, further comprising information output means for displaying an image,
wherein said modifying means displays a user interface on said information output means for showing a modification principle which defines that strictness is required for an behavior model, and a modification principle which defines that strictness is not required for an behavior model to prompt the user to select one of the modification principles.

12. The behavior model generator system according to claim 6, wherein:
said behavior model generating means generates, in accordance with the security policy stored in said policy storing means, an behavior model in a first description format which describes that data is permitted to transmit when a transmission permission condition is satisfied and describes that data is prohibited from transmitting when the transmission permission condition is not satisfied, and an behavior model in a second description format which describes that data is prohibited from transmitting when a transmission prohibition condition is satisfied and describes that data is permitted to transmit when the transmission prohibition condition is not satisfied, and
said modifying means is responsive to a modification principle entered through said modification principle input means, said modification principle defining a modification to an behavior model in the second description format, for modifying the behavior model in the first description format to convert the same to an behavior model in the second description format, and is responsive to a modification principle entered through said modification principle input means, said modification principle defining a modification to an behavior model in the first description format, for modifying the behavior model in the second description format to an behavior model in the first description format.

13. The behavior model generator system according to claim 12, further comprising information output means for displaying an image, wherein:
said modifying means displays a user interface on said information output means for showing a modification principle which defines a modification to an behavior model in the second description format, a modification principle which defines a modification to an behavior model in the first description format, and a modification principle which defines that no modification is made to an behavior model to prompt the user to select one of the modification principles.

14. The behavior model generator system according to claim 6, wherein said modifying means is responsive to a modification principle entered through said modification principle input means, said modification principle defining that efficiency is required for the operation of a device, for modifying an behavior model to a form which enables a higher operation of said network access controller.

15. The behavior model generator system according to claim 14, further comprising information output means for displaying an image, wherein:
said modifying means displays a user interface on said information output means for displaying a modification principle which defines that efficiency is required for the operation of a device, and a modification principle which defines that efficiency is not required for the operation of a device to prompt the user to select one of the modification principles.

16. The behavior model generator system according to claim 7, wherein said modifying means displays a user interface on said information output means which displays an behavior model generated by said behavior model generating means as a single diagram.

17. The behavior model generator system according to claim 16, wherein said modifying means modifies an behavior model displayed as a diagram on the user interface in accordance with a modification principle entered through said modification principle input means.

18. The behavior model generator system according to claim 6, wherein said modifying means is responsive to a modification principle entered through said modification principle input means, said modification principle being applied to each behavior model which has not been modified, for modifying each behavior model which has not been modified in accordance with the modification principle.

19. The behavior model generator system according to claim 6, further comprising information output means for displaying an image, wherein:
said modifying means displays a modified behavior model on said information output means as a diagram.

20. The behavior model generator system according to claim 1, further comprising information output means for displaying an image, wherein:
said behavior model generating means displays a generated behavior model on said information output means as a diagram.

21. An behavior model generating method comprising the steps of:
policy storing means storing a security policy including at least a transmission permission condition or a transmission prohibition condition for communicated data;
topology storing means storing topology information which describes information on a device connected to a communication network to which a network access controller is connected, said network access controller performing at least an operation for permitting the communicated data to transmit or an operation for prohibiting the communicate data from transmitting; and
behavior model generating means generating an behavior model based on the security policy stored in said policy storing means, said behavior model including data representative of the operation of said network access controller for each device described in the topology information.

22. The behavior model generating method according to claim 21, further comprising the steps of:
entering a security policy through policy input means; and storing the security policy in policy storing means.

23. The behavior model generating method according to claim 21, further comprising the steps of:
entering topology information through topology information input means; and
storing the topology information in topology storing means.

24. The behavior model generating method according to claim 21, further comprising the steps of:
policy normalizing means executing normalization when the security policy does not include a description related to a predefined item for adding a description related to the item to the security policy; and
an behavior model generating means generating an behavior model based on the normalized security policy.

25. An behavior model generating program, when run on a computer comprising policy storing means for storing a security policy including at least a transmission permission condition or a transmission prohibition condition for communicated data, and topology storing means for storing topology information which describes information on a device connected to a communication network to which a network access controller is connected, said network access controller performing at least an operation for permitting the communicated data to transmit or an operation for prohibiting the communicate data from transmitting, causing said computer to execute processing for generating an behavior model based on the security policy stored in said policy storing means, said behavior model including data representative of the operation of said network access controller for each device described in the topology information.
